(19) United States
(12) Patent Application Publication
(10) Pub. No.: US 2025/0347566 A1
(43) Pub. Date: Nov. 13, 2025

(54) SENSOR DEVICE

(71) Applicant: SAMSUNG ELECTRONICS CO., LTD., Suwon-si (KR)

(72) Inventors: Geunyong PARK, Suwon-si (KR); Hyunjoon CHOO, Suwon-si (KR)

(73) Assignee: SAMSUNG ELECTRONICS CO., LTD., Suwon-si (KR)

(21) Appl. No.: 19/273,351

(22) Filed: Jul. 18, 2025

Related U.S. Application Data
(63) Continuation of application No. PCT/KR2023/019898, filed on Dec. 5, 2023.

(30) Foreign Application Priority Data
Jan. 20, 2023 (KR) 10-2023-0009030

(51) Int. Cl. G01K 1/14; G01K 1/024

(52) U.S. Cl. CPC G01K 1/14; G01K 1/024

(57) ABSTRACT

A sensor device mountable on cooking apparatuses having various shapes. The sensor device including a main body part, a mounting part arrangeable to be fixed to one end of the main body part and while the mounting part is fixed to one end of the main body part, the mounting part is configured to extend along one direction and be bendable one or more times including being bent along the one direction subsequent to being bent along a predetermined direction different from the one direction, and a sensor unit arrangeable to be fixed to one end of the mounting part.

### CROSS-REFERENCE TO RELATED APPLICATION(S)

This application is a continuation application, claiming priority under § 111 (a), of International Application No. PCT/KR2023/019898, filed on Dec. 5, 2023, which is based on and claims the benefit of Korean Patent Application No.: 10-2023-0009030, filed Jan. 20, 2023, in the Korean Intellectual Property Office, the disclosures of which are incorporated by reference herein in their entireties.

### TECHNICAL FIELD

The present disclosure relates to a sensor device capable of sensing the temperature of a target object by contact.

### BACKGROUND ART

A cooking appliance may be equipped with a sensor device for checking the temperature of food being cooked. During use of the sensor device, a sensor unit for temperature sensing needs to maintain contact with the food. To this end, the sensor unit needs to be inserted into the food accommodated in a cooking apparatus and fixed therein.

The shape of the cooking apparatus and the cooking environment for cooking food may vary depending on the type of food. To sense the temperature of food, the sensor unit included in the sensor device needs to maintain contact with the food, that is, the target object. When the sensor unit maintains contact with the food, that is, the target object, limitations in accurately measuring the temperature may arise due to changes in the environment in which the food is being cooked or due to a difficulty fixing the sensor unit to the food.

### DISCLOSURE OF INVENTION

### Solution to Problem

A sensor device according to an example may include a main body part, a mounting part arrangeable to be fixed to one end of the main body part and while the mounting part is fixed to one end of the main body part, the mounting part is configured to extend along one direction, be bent one or more times including being bent along the one direction subsequent to being bent along a predetermined direction different from the one direction, and a sensor unit arrangeable to be fixed to one end of the mounting part.

A sensor device according to an example may include a main body part, a mounting part arrangeable to be fixed to one end of the main body part and while the mounting part is fixed to one end of the main body part, the mounting part is configured to extend along one direction, a sensor unit arrangeable to be fixed to one end of the mounting part, and a holder including a support part that is bent at a predetermined angle, and one or more through-holes arranged in the support part and into which the mounting part is insertable.

A sensor device according to an example may include a main body part, a mounting part arrangeable to be fixed to one end of the main body part and while the mounting part is fixed to one end of the main body part, the mounting part is configured to extend along one direction, a sensor unit arrangeable to be fixed to one end of the mounting part, and a position fixing part arrangeable spaced apart from the mounting part with a predetermined gap therebetween in another direction perpendicular to the one direction.

### BRIEF DESCRIPTION OF DRAWINGS

FIG. 1 is a schematic diagram illustrating a home appliance system according to an example.

FIG. 2 is a front view of a sensor device according to an example.

FIG. 3 is a block diagram of a sensor device according to an example.

FIG. 4 is a cross-sectional view of a cooking apparatus equipped with a sensor device, according to an example.

FIG. 5 is a cross-sectional view of a cooking apparatus equipped with a sensor device, according to an example.

FIG. 6A is a cross-sectional view of a cooking apparatus equipped with a sensor device, according to an example.

FIG. 6B is an enlarged view of region M of FIG. 6A, according to an example.

FIG. 7A is a perspective view of a first holder according to an example.

FIG. 7B is a cross-sectional view of a first holder according to an example.

FIG. 7C is a cross-sectional view of a first holder according to an example.

FIG. 8 is a cross-sectional view of a cooking apparatus equipped with a sensor device, according to an example.

FIG. 9 is a cross-sectional view of a cooking apparatus equipped with a sensor device, according to an example.

FIG. 10 is a cross-sectional view of a cooking apparatus equipped with a sensor device, according to an example.

FIG. 11 is a perspective view of a sensor device according to an example.

FIG. 12A is a cross-sectional view of a sensor device according to an example.

FIG. 12B is a cross-sectional view of a cooking apparatus equipped with a sensor device, according to an example.

FIG. 13A is a cross-sectional view of a sensor device according to an example.

FIG. 13B is a cross-sectional view of a cooking apparatus equipped with a sensor device, according to an example.

FIG. 14 is a perspective view of a sensor device according to an example.

FIG. 15A is a cross-sectional view of a cooking apparatus equipped with a sensor device, according to an example.

FIG. 15B is a cross-sectional view of a cooking apparatus equipped with a sensor device, according to an example.

FIG. 16 is a perspective view of a sensor device according to an example.

FIG. 17 is a perspective view of a sensor device according to an example.

FIG. 18 is a cross-sectional view of a cooking apparatus equipped with a sensor device, according to an example.

FIG. 19 is a cross-sectional view of a cooking apparatus equipped with a sensor device, according to an example.

FIG. 20A is a perspective view of a sensor device according to an example.

FIG. 20B is a partial enlarged view of a sensor device according to an example.

FIG. 21A is a perspective view of a sensor device according to an example.

FIG. 21B is a partial enlarged view of a sensor device according to an example.

FIG. 22A is a perspective view of a sensor device according to an example.

FIG. 22B is a partial cross-sectional view of a sensor device according to an example.

FIG. 23 is a perspective view of a sensor device according to an example.

FIG. 24A is a side view of a sensor device according to an example.

FIG. 24B is a side view of a sensor device according to an example.

FIG. 24C is a side view of a sensor device according to an example.

### MODE FOR THE INVENTION

It should be appreciated that various embodiments disclosed herein and the terms used for describing the embodiments are not intended to limit the technological features set forth herein to particular embodiments, and include various changes, equivalents, or alternatives for a corresponding embodiment.

With regard to the description of the drawings, similar reference numerals may be used to refer to similar or related elements.

A singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

As used herein, such terms as “1st” and “2nd,” or “first” and “second” may be used to simply distinguish a corresponding component from another, and does not limit the components in any other respect (e.g., importance or order).

When an element (e.g., a first element) is referred to, with or without the term “operatively” or “communicatively”, as being “coupled with,” “coupled to,” “connected with,” or “connected to” another element (e.g., a second element), it means that the element may be connected to the other element directly (e.g., in a wired manner), wirelessly, or via a third element.

As used herein, such terms as “comprises,” “includes,” or “has” specify the presence of stated features, numbers, stages, operations, components, parts, or a combination thereof, but do not preclude the presence or addition of one or more other features, numbers, stages, operations, components, parts, or a combination thereof.

When an element is referred to as being “connected to,” “coupled to,” “supported by,” or “in contact with” another element, it means that the element is directly connected to, coupled to, supported by, or in contact with the other element, or that the element is indirectly connected to, coupled to, supported by, or in contact with the other element via a third element.

When an element is referred to as being “on” another element, it means that the element is in contact with the other element, or that still another element is present between the element and the other element.

As used herein, the term “and/or” includes any one or a combination of a plurality of related recited elements.

Hereinafter, the principle of operation and embodiments of the present disclosure will be described with reference to the accompanying drawings.

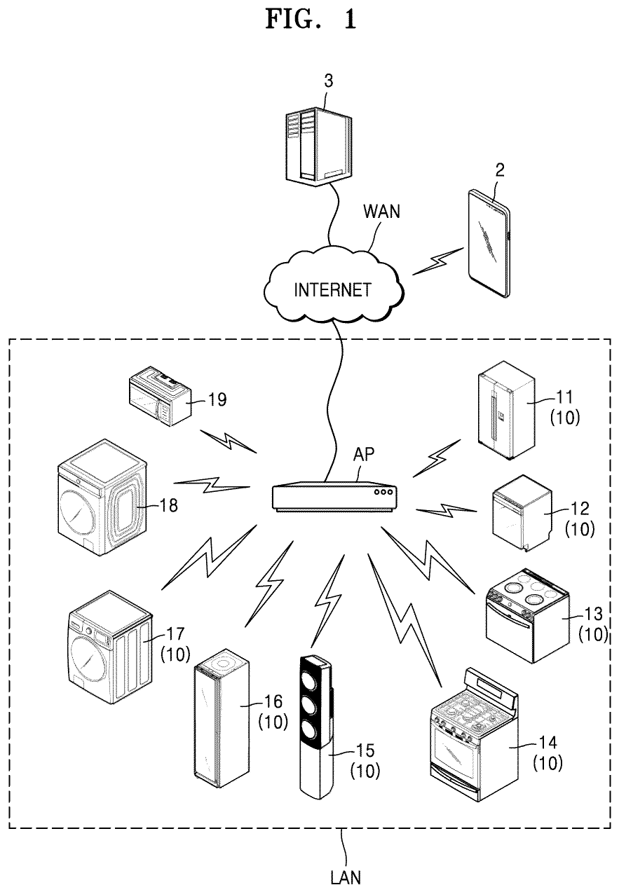

FIG. 1 is a schematic diagram illustrating a home appliance system according to an example.

A home appliance 10 may include a communication module capable of communicating with other home appliances, a user device 2, or a server 3, a user interface configured to receive a user input or output information to a user, at least one processor configured to control the operation of the home appliance 10, and at least one memory storing a program for controlling the operation of the home appliance 10.

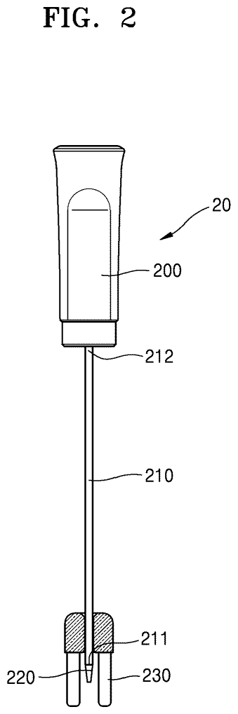

The home appliances 10 may include at least one of various types of home appliances. For example, as illustrated, the home appliances 10 may include, but are not limited to, at least one of a refrigerator 11, a dishwasher 12, an electric range 13, an electric oven 14, an air conditioner 15, a clothing care apparatus 16, a washing machine 17, a dryer 18, a microwave oven 19, and a sensor device 20 (see FIG. 2), and for example, the home appliances 10 may include various types of home appliances not illustrated in the drawings, such as a cleaning robot, a vacuum cleaner, or a television. In addition, the above home appliances are merely examples, and in addition to these home appliances, any device connectable to other home appliances, the user device 2, or the server 3 to perform operations described below may be included in the home appliances 10 according to an embodiment.

The server 3 may include a communication module capable of communicating with other servers, the home appliances 10, or the user device 2, at least one processor capable of processing data received from the other servers, the home appliances 10, or the user device 2, and at least one memory capable of storing a program for processing data or processed data. The server 3 may be implemented as various computing devices, such as a workstation, a cloud server, a data drive, or a data station. The server 3 may be implemented as one or more servers that are physically or logically separated from each other based on their functions, detailed configurations, data, or the like, and may exchange data via communication between the respective servers and process the exchanged data.

The server 3 may perform functions such as managing user accounts, registering the home appliance 10 in association with a user account, or managing or controlling the registered home appliance 10. For example, a user may connect to the server 3 through the user device 2 and create a user account. The user account may be identified by an identifier (ID) and a password both set by the user. The server 3 may register the home appliance 10 with the user account according to a predetermined procedure. For example, the server 3 may register, manage, and control the home appliance 10 by linking identification information of the home appliance 10 (e.g., a serial number or a medium access control (MAC) address) to the user account. The user device 2 may include a communication module capable of communicating with the home appliances 10 or the server 3, a user interface configured to receive a user input or output information to the user, at least one processor configured to control the operation of the user device 2, and at least one memory storing a program for controlling the operation of the user device 2.

The user device 2 may be carried by the user or may be placed in the user's home or office. The user device 2 may include a personal computer, a terminal, a portable telephone, a smart phone, a handheld device, a wearable device, and the like, but is not limited thereto.

The memory of the user device 2 may store a program, that is, an application, for controlling the home appliance 10. The application may be sold pre-installed on the user device 2, or may be downloaded from an external server and then installed.

By executing the application installed on the user device 2, the user may connect to the server 3, create a user account, and register the home appliance 10 by communicating with the server 3 based on the logged-in user account.

For example, when the user manipulates the home appliance 10 according to a procedure provided by the application installed on the user device 2 so as to connect the home appliance 10 to the server 3, the home appliance 10 may be registered with the user account by the server 3 registering identification information (e.g., a serial number or a MAC address) of the home appliance 10 with the user account.

The user may control the home appliance 10 by using the application installed on the user device 2. For example, when the user logs into a user account by using the application installed on the user device 2, home appliances 10 registered with the user account may be displayed, and when the user inputs a control command for a home appliance 10, the control command may be transmitted to the home appliance 10 via the server 3.

The network may include both a wired network and a wireless network. The wired network may include a cable network or a telephone network, and the wireless network may include any network for transmitting and receiving signals through radio waves. The wired network and the wireless network may be connected to each other.

The network may include a wide area network (WAN) such as the Internet, a local area network (LAN) configured around an access point (AP), and a short-range wireless network that does not go through an AP. The short-range wireless network may include Bluetooth™ (Institute of Electrical and Electronics Engineers (IEEE) 802.15.1), Zigbee (IEEE 802.15.4), WFD, near-field communication (NFC), Z-Wave, and the like, but is not limited thereto.

The AP may connect the home appliance 10 or the user device 2 to a WAN to which the server 3 is connected. The home appliance 10 or the user device 2 may be connected to the server 3 via the WAN.

The AP may communicate with the home appliance 10 or the user device 2 by using wireless communication protocols such as Wi-Fi (IEEE 802.11), Bluetooth (IEEE 802.15.1), or Zigbee (IEEE 802.15.4), and may connect to the WAN by using wired communication, but is not limited thereto.

According to various embodiments, the home appliance 10 may also be directly connected to the user device 2 or the server 3 without going through the AP.

The home appliance 10 may be connected to the user device 2 or the server 3 via a long-range wireless network or a short-range wireless network.

For example, the home appliance 10 may be connected to the user device 2 via a short-range wireless network (e.g., Wi-Fi Direct).

As another example, the home appliance 10 may be connected to the user device 2 or the server 3 via the WAN by using a long-range wireless network (e.g., a cellular communication module).

As another example, the home appliance 10 may connect to the WAN by using wired communication, and be connected to the user device 2 or the server 3 via the WAN.

When the home appliance 10 is able to connect to the WAN by using wired communication, the home appliance 10 may also operate as an AP. Accordingly, the home appliance 10 may connect another home appliance to the WAN to which the server 3 is connected. In addition, another home appliance may connect the home appliance 10 to the WAN to which the server 3 is connected.

The home appliance 10 may transmit information about an operation or state of the home appliance 10 to another home appliance, the user device 2, or the server 3 via the network. For example, the home appliance 10 may transmit information about an operation or state to another home appliance, the user device 2, or the server 3, when a request is received from the server 3, when a particular event occurs at the home appliance 10, or periodically or in real time. Upon receiving the information about the operation or state from the home appliance 10, the server 3 may update previously stored information about an operation or state of the home appliance 10, and transmit the updated information about the operation and state of the home appliance 10 to the user device 2 via the network. Here, updating information may include various operations in which existing information is changed, such as an operation of adding new information to existing information or an operation of replacing existing information with new information.

The home appliance 10 may obtain various pieces of information from another home appliance, the user device 2, or the server 3, and provide the obtained information to the user. For example, the home appliance 10 may obtain, from the server 3, information associated with a function of the home appliance 10 (e.g., recipes or washing methods) and various pieces of environmental information (e.g., weather, temperature, or humidity), and output the obtained information via a user interface.

The home appliance 10 may operate according to a control command received from another home appliance, the user device 2, or the server 3. For example, in a case in which the home appliance 10 has obtained prior user approval to operate according to control commands from the server 3 even without a user input, the home appliance 10 may operate according to control commands received from the server 3. Here, the control commands received from the server 3 may include, but are not limited to, control commands input by a user via the user device 2 or control commands based on preset conditions.

The user device 2 may transmit information about the user to the home appliance 10 or the server 3 via the communication module. For example, the user device 2 may transmit, to the server 3, information about the user's location, health status, preferences, schedule, or the like. The user device 2 may transmit information about the user to the server 3 according to prior user approval.

The home appliance 10, the user device 2, or the server 3 may determine a control command by using technology such as artificial intelligence. For example, the server 3 may receive information about an operation or state of the home appliance 10 or information about the user, process the received information by using technology such as artificial intelligence, and, based on the processing result, transmit the processing result or a control command to the home appliance 10 or the user device 2.

Hereinafter, the sensor device 20, among the above-described home appliances 10, which is able to sense the temperature of a target object (e.g., food) by contact, and transmit the obtained information to the server 3, the user device 2, or another home appliance 10 will be described.

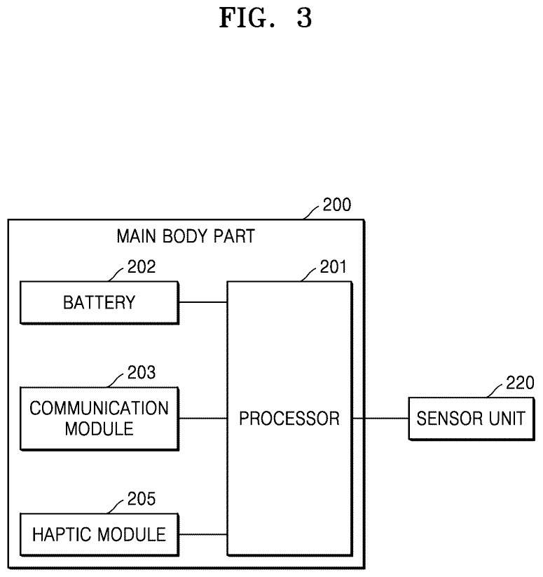

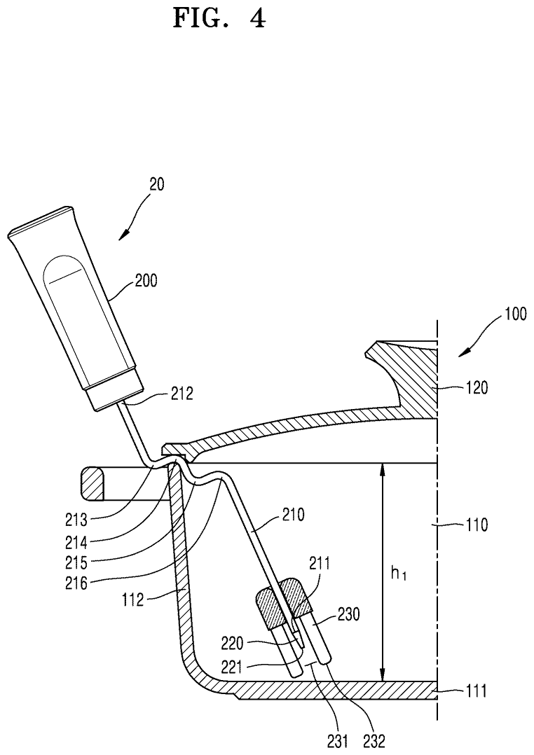

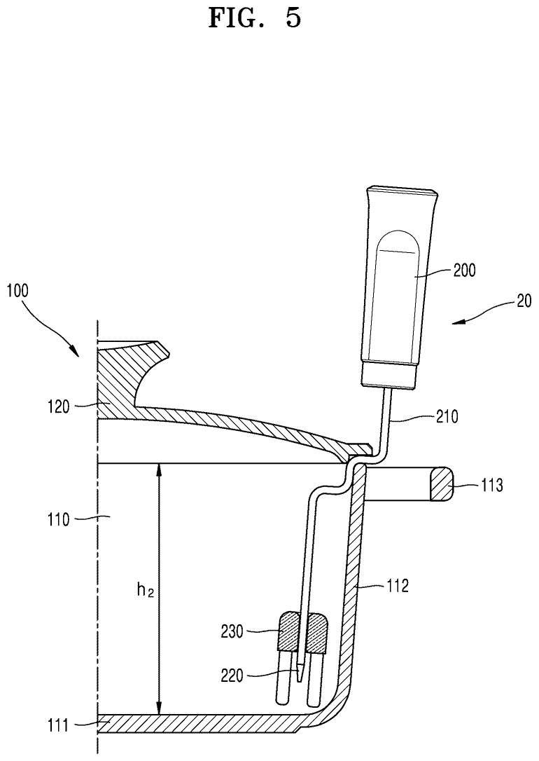

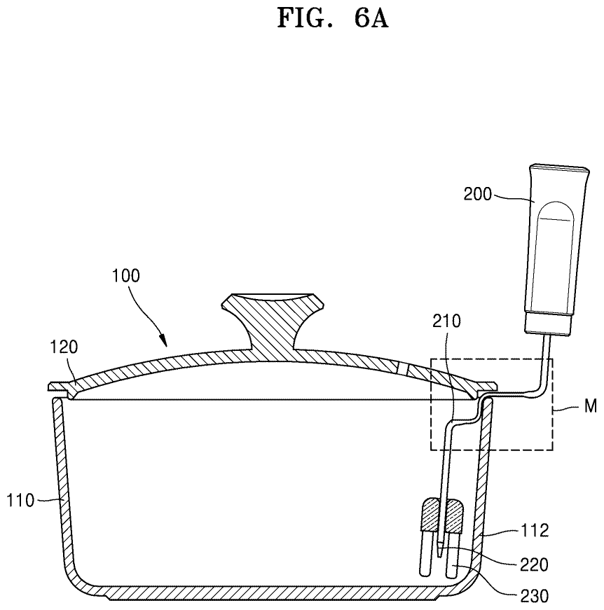

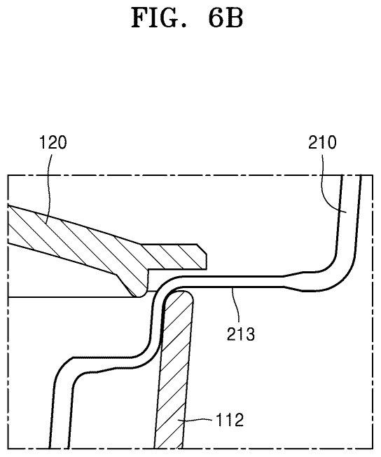

FIG. 2 is a front view of a sensor device according to an example. FIG. 3 is a block diagram of a sensor device according to an example. FIG. 4 is a cross-sectional view of a cooking apparatus equipped with a sensor device, according to an example. FIG. 5 is a cross-sectional view of a cooking apparatus equipped with a sensor device, according to an example. FIG. 6A is a cross-sectional view of a cooking apparatus equipped with a sensor device, according to an example. FIG. 6B is an enlarged view of region M of FIG. 6A.

Referring to FIGS. 2, 3, and 4, the sensor device 20 according to an example may include a main body part 200, a mounting part 210 arranged to be fixed to one end of the main body part 200, a sensor unit 220 arranged to be fixed to one end of the mounting part 210, and a position adjustment unit 230. The main body part 200 according to an example may have an external appearance configured to be gripped by a user. For example, the main body part 200 may have a rod shape extending in one direction, but the present disclosure is not limited thereto.

The main body part 200 according to an example may support various components included in the sensor device 20. For example, the main body part 200 may include a housing with a certain accommodation space. The main body part 200 may include various materials (e.g., a synthetic resin material, a metal material, or a composite material). Here, the main body part 200 may include both a portion forming the external appearance of the sensor device 20 and a portion forming the internal structure of the sensor device 20.

As described above, the main body part 200 may include various components included in the sensor device 20, for example, at least one of a processor 201, a battery 202, a communication module 203, and a haptic module 205. The processor 201 according to an example may be electrically connected to the battery 202, the communication module 203, the haptic module 205, and the sensor unit 220, and may control these components.

The battery 202 may supply power to at least one component of the sensor device 20. According to an example, the battery 202 may include, for example, a non-rechargeable primary cell, a secondary cell rechargeable via wired or wireless methods, or a fuel cell. For example, the sensor device 20 may include a power management module (not shown) configured to manage power supplied to the sensor device 20. The power management module (not shown) may be implemented, for example, as at least part of a power management integrated circuit (PMIC).

The communication module 203 may support establishing a direct (e.g., wired) communication channel or a wireless communication channel between the sensor device 20 and an external electronic device (e.g., the user device 2 or the server 3), and performing communication via the established communication channel. The communication module 203 may include one or more communication processors that operate independently of the processor 201 (e.g., an application processor) and support direct (e.g., wired) communication or wireless communication.

According to an example, the communication module 203 may include a wireless communication module (e.g., a cellular communication module, a short-range wireless communication module, or a global navigation satellite system (GNSS) communication module) or a wired communication module (e.g., a LAN communication module or a power line communication module). The corresponding communication module may communicate with the external user device 2 or server 3 through a first network (e.g., a short-range communication network such as Bluetooth, Wi-Fi Direct, or Infrared Data Association (IrDA)) or a second network (e.g., a long-range communication network such as a legacy cellular network, a 5G network, a next-generation communication network, the Internet, or a computer network (e.g., a LAN or a wide area network (WAN)).

The haptic module 205 may convert an electrical signal into a mechanical stimulus (e.g., vibration or movement) or an electrical stimulus that a user may perceive through tactile or motion sensation. According to an example, the haptic module 205 may include, for example, a motor, a piezoelectric element, or an electrical stimulation device.

The mounting part 210 may be arranged between the main body part 200 and the sensor unit 220 to connect the main body part 200 and the sensor unit 220 to each other. The mounting part 210 according to an example may extend in one direction. Here, one end 211 of the mounting part 210 may be arranged to be fixed to the sensor unit 220. In addition, another end 212 of the mounting part 210 may be arranged to be fixed to the main body part 200. The mounting part 210 according to an example may be formed integrally between the main body part 200 and the sensor unit 220.

The mounting part 210 according to an example may be bent one or more times in a certain direction. For example, the mounting part 210 may include a tube shape that may be bent clockwise or counterclockwise along a longitudinal direction in which the mounting part 210 extends. For example, the mounting part 210 may be bent clockwise or counterclockwise by an angle greater than 0 degrees and less than 150 degrees in the longitudinal direction in which the mounting part 210 extends.

As illustrated in FIG. 4, food, which is a target object, may be accommodated in a cooking apparatus 100. Here, the sensor unit 220 may be arranged to be in direct contact with the food, which is the target object. In addition, here, the sensor device 20 may be arranged to be mounted on the cooking apparatus 100. According to an example, the shape of the mounting part 210 may be deformed to correspond to the shape of the cooking apparatus 100 in which the sensor device 20 is accommodated.

For example, the cooking apparatus 100 may include an accommodation part 110 in which a target object is to be accommodated, and a cover part 120 that opens and closes one surface of the accommodation part 110. For example, in a case in which the target object is food, the accommodation part 110 may be a pot, and the cover part 120 may be a lid. During cooking of the food, when the cover part 120 is not closed, thermal efficiency may decrease, and the cooking time for the food may increase. Thus, during cooking of the food, it may be desirable for the cover part 120 to close one surface of the accommodation part 110.

When the cover part 120 closes one surface of the accommodation part 110, the mounting part 210 may be arranged between a side surface 112 of the accommodation part 110 and a peripheral portion of the cover part 120. According to an example, the shape of the mounting part 210 may be deformed to correspond to the shape of a region between the side surface 112 of the accommodation part 110 and the peripheral portion of the cover part 120. For example, as illustrated in FIG. 4, the mounting part 210 may be deformed to include a first bent portion 213 and a second bent portion 214. Here, the first bent portion 213 may be bent in a counterclockwise direction. In addition, here, the second bent portion 214 may be bent in a clockwise direction. Here, because the first bent portion 213 and the second bent portion 214 may be in direct contact with the side surface 112 of the accommodation part 110 and the cover part 120, they may include a material having certain heat resistance. For example, the mounting part 210 may include at least one of a silicone tube or a stainless steel tube. However, the present disclosure is not limited thereto, and the mounting part 210 may include any material that has heat resistance and has a deformable elastic force allowing it to be bent in a certain direction.

According to an example, the mounting part 210 may include a material deformable in a thickness direction when external pressure is applied. As illustrated in FIGS. 6A and 6B, when pressure is applied in the thickness direction of the mounting part 210 by the side surface 112 of the accommodation part 110 and the cover part 120, the mounting part 210 may be deformed in the thickness direction. For example, a partial region 213 of the mounting part 210 may be deformed in the thickness direction such that its thickness is reduced to 30% to 50% of the total thickness. However, the present disclosure is not limited thereto, and the mounting part 210 may also be deformed into any shape corresponding to the shape of a region between the side surface 112 of the accommodation part 110 and the cover part 120, so as to improve sealing between the side surface 112 of the accommodation part 110 and the cover part 120.

Referring again to FIG. 4, the sensor unit 220 may be arranged at the end 211 of the mounting part 210. Here, the sensor unit 220 needs to be in direct contact with the target object arranged in a lower portion of the accommodation part 110, and thus needs to be oriented toward a bottom surface 111 of the accommodation part 110. According to an example, the shape of the mounting part 210 may be deformed such that the sensor unit 220 arranged at the end 211 of the mounting part 210 faces the bottom surface 111 of the accommodation part 110. For example, the mounting part 210 may be deformed to include a third bent portion 215 and a fourth bent portion 216. Here, the third bent portion 215 may be bent in a counterclockwise direction. In addition, here, the fourth bent portion 216 may be bent in a clockwise direction. Although the above-described example describes the mounting part 210 being bent four times, the present disclosure is not limited thereto, and the mounting part 210 may also be bent four or more times or fewer than four times, depending on the shape of the accommodation part 110.

The sensor unit 220 is a temperature sensing unit configured to be in contact with a target object and measure the temperature of the target object. For example, in a case in which the target object is food, the sensor unit 220 may be a temperature sensing unit configured to be in direct contact with the food and measure the temperature of the food. However, the present disclosure is not limited thereto, and the sensor unit 220 may include any temperature sensing unit configured to be placed close to a target object and sense the temperature of the target object.

According to an example, the sensor unit 220 may be arranged at the end 211 of the mounting part 210. As described above, the mounting part 210 may be deformed such that the sensor unit 220 may be in direct contact with the target object. Accordingly, the sensor unit 220 may come into direct contact with the target object and sense the temperature of the target object, regardless of the position of the target object.

The position adjustment unit 230 may be arranged to surround a portion of the sensor unit 220 and adjust the position of the sensor unit 220. The position adjustment unit 230 according to an example may include a material having a certain weight. For example, the position adjustment unit 230 may be provided in the shape of a weight including stainless steel. However, the present disclosure is not limited thereto, and the position adjustment unit 230 may have any shape with a certain weight that adjusts the position of the sensor unit 220.

According to an example, the position adjustment unit 230 may adjust the position of the sensor unit 220 such that the sensor unit 220 is fixed in position to face the bottom surface 111 of the accommodation part 110. According to an example, the sensor unit 220 needs to be in direct contact with the target object arranged in a lower portion of the accommodation part 110, and thus needs to be oriented toward the bottom surface 111 of the accommodation part 110. Here, the shape of the mounting part 210 may be deformed such that the sensor unit 220 arranged at the end 211 of the mounting part 210 faces the bottom surface 111 of the accommodation part 110.

According to an example, the sensor unit 220 may be adjusted in position to face the bottom surface 111 of the accommodation part 110 even when the height of the side surface 112 of the accommodation part 110 varies. For example, as illustrated in FIG. 4, the side surface 112 of the accommodation part 110 may have a first height h₁, and as illustrated in FIG. 5, the side surface 112 of the accommodation part 110 may have a second height h₂ that is greater than the first height h₁. In this case, the position adjustment unit 230 may apply pressure to the mounting part 210 such that the end 211 of the mounting part 210 faces the bottom surface of the accommodation part 110, regardless of the height of the side surface 112 of the accommodation part 110. In addition, the position adjustment unit 230 may fix the position of the sensor unit 220 to prevent the position of the sensor unit 220 from changing due to a movement of the target object (e.g., food).

The position adjustment unit 230 according to an example may include a through-hole 231 extending in one direction. The sensor unit 220 may be inserted into the through-hole 231 and arranged to be fixed to the position adjustment unit 230. For example, one end 221 of the sensor unit 220 and one end 232 of the position adjustment unit 230 may be arranged spaced apart from each other with a certain gap therebetween. Accordingly, the end 221 of the sensor unit 220 may be prevented from extending beyond the end 232 of the position adjustment unit 230 and being exposed to the outside. Because the end 221 of the sensor unit 220 is not exposed to the outside, the end 221 of the sensor unit 220 may be prevented from being supported on the bottom surface 111 of the accommodation part 110. Accordingly, an error may be prevented where the sensor unit 220 comes into direct contact with the bottom surface 111 and senses the temperature of the bottom surface 111 as the temperature of the target object. In addition, as the food, which is the target object, is inserted through the through-hole 231 that is arranged in the sensor unit 220 to come into contact with the end 221 of the sensor unit 220, the temperature of the target object may be measured more accurately.

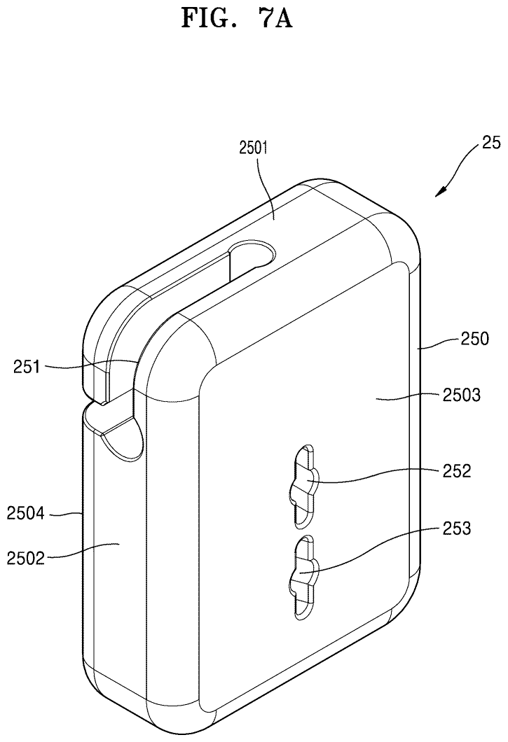

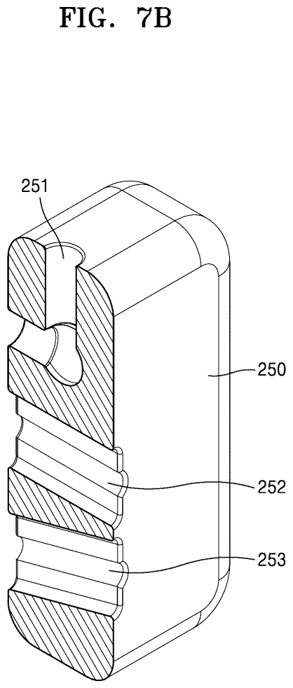

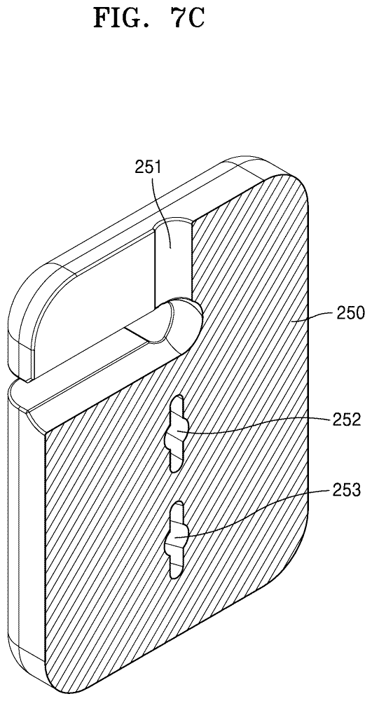

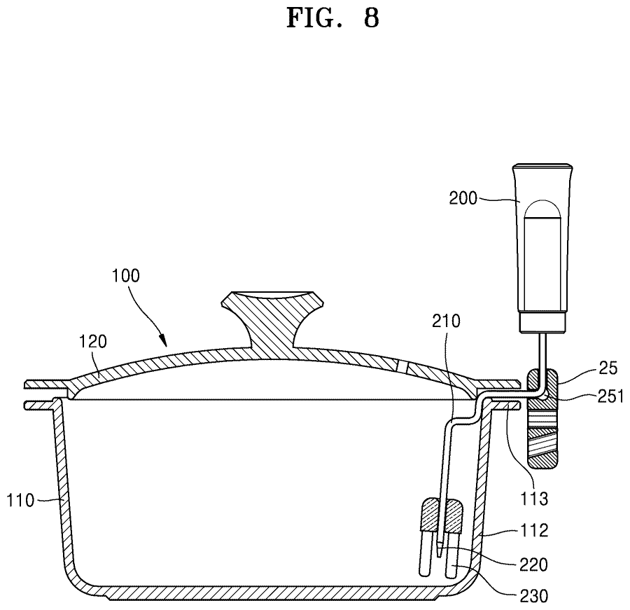

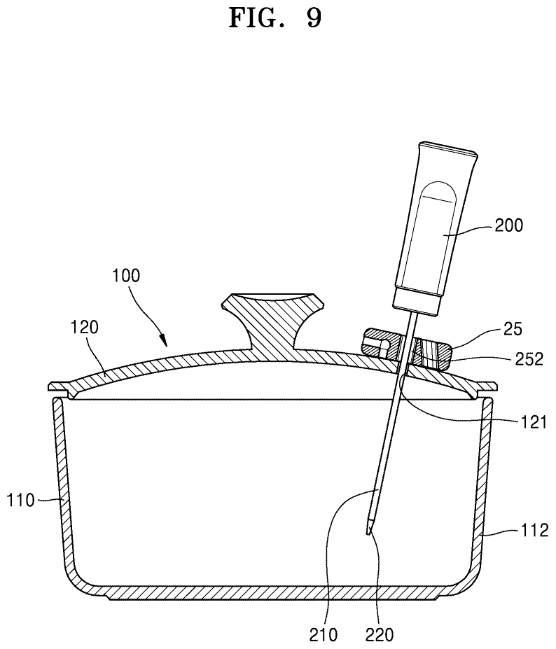

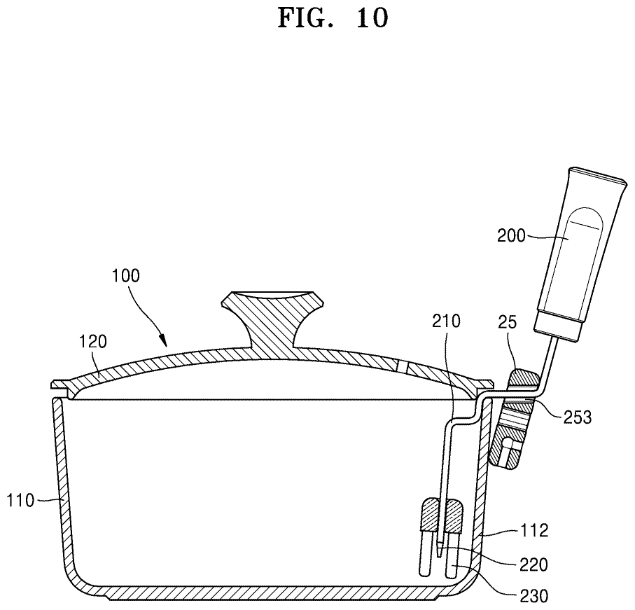

FIG. 7A is a perspective view of a first holder according to an example. FIG. 7B is a cross-sectional view of a first holder according to an example. FIG. 7C is a cross-sectional view of a first holder according to an example. FIG. 8 is a cross-sectional view of a cooking apparatus equipped with a sensor device, according to an example. FIG. 9 is a cross-sectional view of a cooking apparatus equipped with a sensor device, according to an example. FIG. 10 is a cross-sectional view of a cooking apparatus equipped with a sensor device, according to an example.

Referring to FIGS. 7A to 10, a first holder 25 according to an example may include a housing 250 and one or more through-holes 251 to 253 arranged in the housing 250. For example, the housing 250 may support the mounting part 210, which is inserted between the side surface 112 of the accommodation part 110 and the cover part 120. According to an example, the housing 250 may have a rectangular parallelepiped shape. In this case, the one or more through-holes 251 to 253 may extend through two surfaces of the housing 250.

According to an example, the first through-hole 251 may have a shape bent at a certain angle along a first side surface 2501 of the housing 250 and a second side surface 2502 arranged adjacent to the first side surface 2501. For example, the first through-hole 251 may have a through-hole shape bent at 90 degrees.

In addition, the second through-hole 252 may have a shape extending in a first direction along an upper surface 2503 and a lower surface 2504 of the housing 250. In addition, the third through-hole 253 may have a shape extending in a second direction inclined at a certain angle with respect to the first direction, along the upper surface 2503 and the lower surface 2504 of the housing 250. For example, the certain angle may be greater than 0 degrees and less than 60 degrees, but the present disclosure is not limited thereto.

According to an example, the second through-hole 252 and the third through-hole 253 may be arranged spaced apart from each other with a certain gap therebetween along a plane parallel to the upper surface 2503 and the lower surface 2504 of the housing 250. Although the above-described example discloses the first holder 25 having three through-holes, the present disclosure is not limited thereto. Two or more through-holes may be provided in the first holder 25 depending on the arrangement of the sensor device 20.

Referring to FIGS. 7A to 7C and FIG. 8, in a case in which the accommodation part 110 of the cooking apparatus 100 according to an example includes a handle 113 having a certain width, the mounting part 210 may pass through the first through-hole 251 and be supported by the first holder 25. Then, the mounting part 210 may pass between the handle 113 and the cover part 120 and be supported. In addition, the mounting part 210 may pass between the side surface 112 of the accommodation part 110 and the cover part 120 and be supported. Here, as the mounting part 210 is additionally supported by the first holder 25, the positions of the main body part 200 and the sensor unit 220 may be stably fixed.

Referring to FIGS. 7A to 7C and FIG. 9, in a case in which the cover part 120 of the cooking apparatus 100 according to an example includes an air outlet 121, the mounting part 210 may pass through the second through-hole 252 and be supported by the first holder 25. In this case, the first holder 25 may be supported by the upper surface of the cover part 120. Then, the mounting part 210 may pass through the air outlet 121 provided in the cover part 120 and be supported. Here, as the mounting part 210 is additionally supported by the first holder 25, the positions of the main body part 200 and the sensor unit 220 may be stably fixed.

Referring to FIGS. 7A to 7C and FIG. 10, in a case in which the accommodation part 110 of the cooking apparatus 100 according to an example does not include the handle 113 having a certain width, the mounting part 210 may pass through the third through-hole 253 and be supported by the first holder 25. Then, the mounting part 210 may pass between the side surface 112 of the accommodation part 110 and the cover part 120 and be supported. Here, as the mounting part 210 is additionally supported by the first holder 25, the positions of the main body part 200 and the sensor unit 220 may be stably fixed.

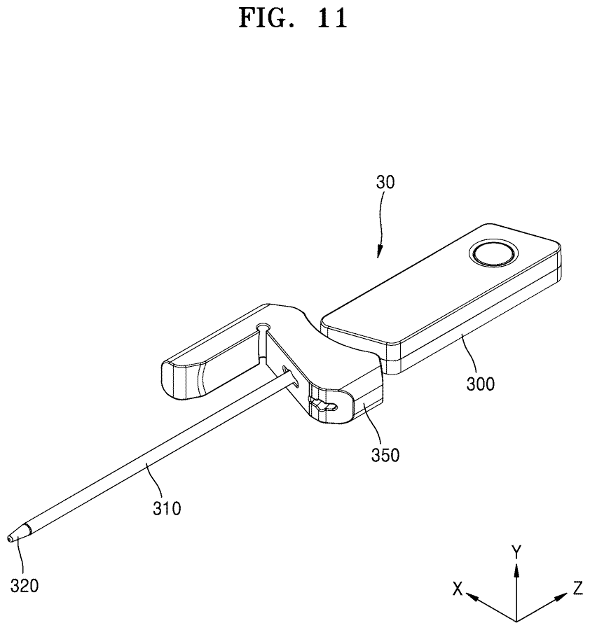

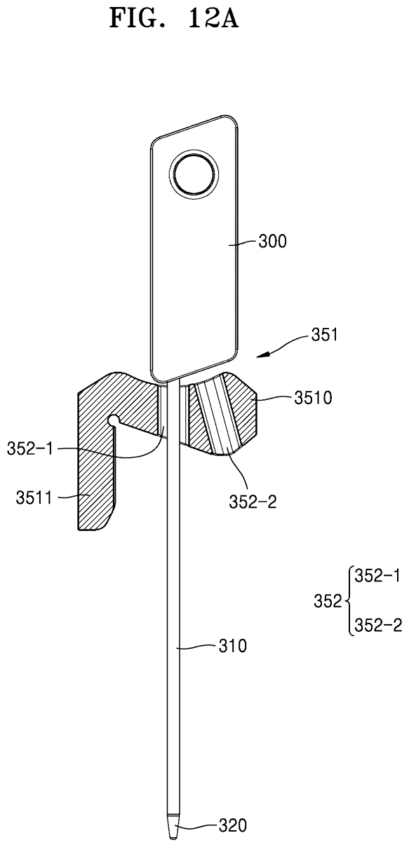

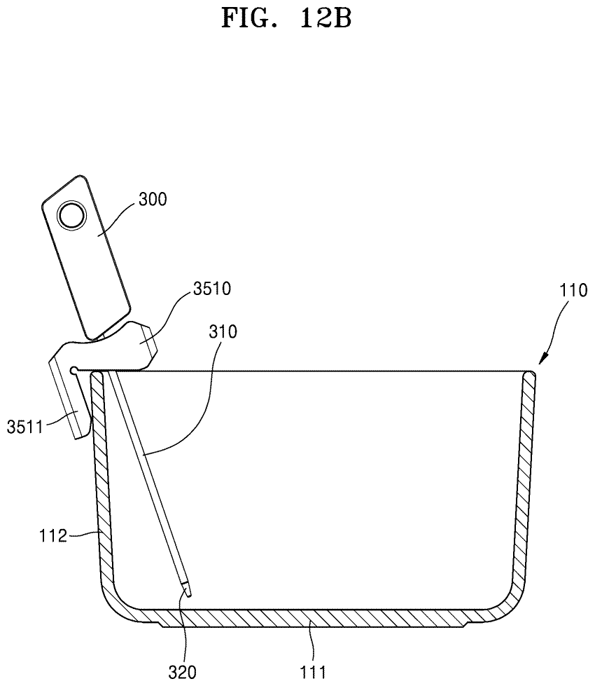

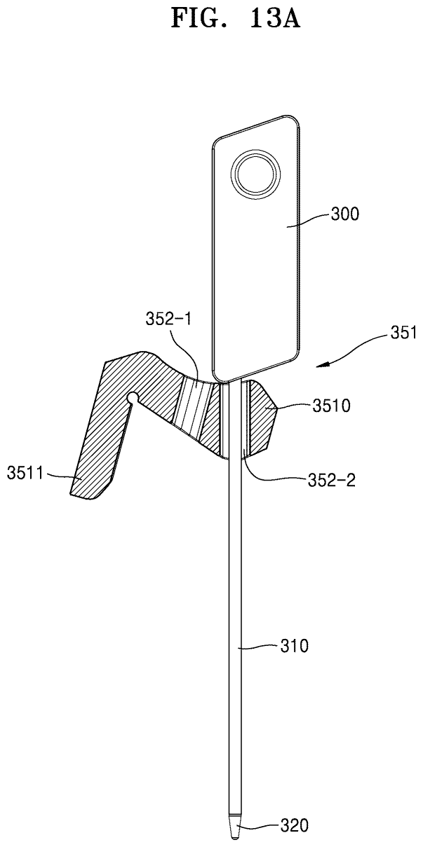

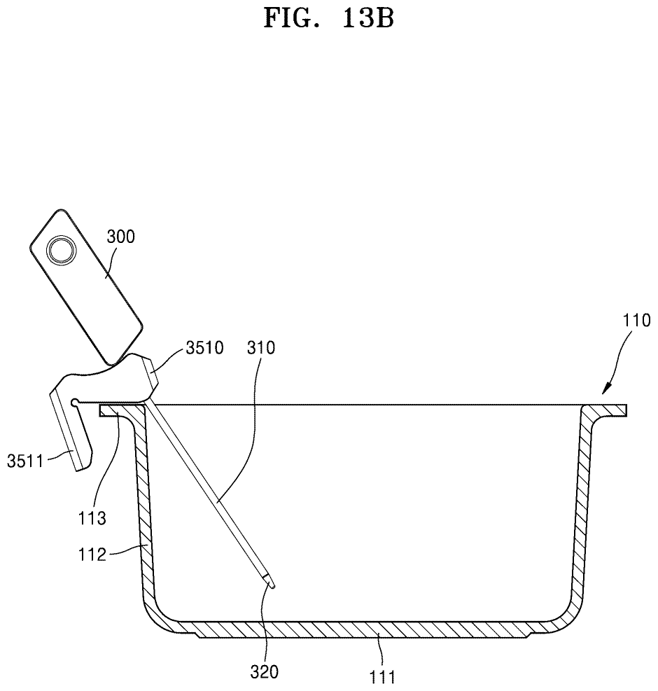

FIG. 11 is a perspective view of a sensor device according to an example. FIG. 12A is a cross-sectional view of a sensor device according to an example. FIG. 12B is a cross-sectional view of a cooking apparatus equipped with a sensor device, according to an example. FIG. 13A is a cross-sectional view of a sensor device according to an example. FIG. 13B is a cross-sectional view of a cooking apparatus equipped with a sensor device, according to an example.

Referring to FIGS. 11 to 12B, a sensor device 30 according to an example may include a main body part 300, a mounting part 310 arranged to be fixed to one end of the main body part 300, a sensor unit 320 arranged to be fixed to one end of the mounting part 310, and a second holder 350. Except that the mounting part 310 according to an example is not bendable clockwise or counterclockwise, the configurations associated with the main body part 300, the mounting part 310, and the sensor unit 320 are substantially the same as those of the main body part 200, the mounting part 210, and the sensor unit 220 described with above reference to FIGS. 2 and 3, and thus, detailed descriptions thereof will be omitted.

According to an example, the second holder 350 may include a support part 351 and one or more through-holes 352 arranged in the support part 351. For example, the support part 351 may have a shape bent at a certain angle. For example, the support part 351 may include a first support part 3510 extending in a first direction, and a second support part 3511 extending in a second direction and connected to one end of the first support part 3510. However, the present disclosure is not limited thereto, and the shape of the support part 351 may include any shape that allows it to be supported corresponding to various shapes of the cooking apparatus 100.

According to an example, a plurality of through-holes 352 may be implemented to correspond to the shape of the cooking apparatus 100. For example, the plurality of through-holes 352 may include a first through-hole 352-1 and a second through-hole 352-2. According to an example, the first through-hole 352-1 may extend through the support part 351 in the first direction. In addition, the second through-hole 352-2 may extend through the support part 351 in the second direction that is inclined at a certain angle with respect to the first direction. For example, the certain angle may be greater than 0 degrees and less than 60 degrees, but the present disclosure is not limited thereto.

According to an example, the first through-hole 352-1 and the second through-hole 352-2 may be arranged in the support part 351 to be spaced apart from each other with a certain gap therebetween. Although the above-described example discloses the second holder 350 having two through-holes, the present disclosure is not limited thereto. Two or more through-holes 352 may be provided in the second holder 350, depending on the shape of the cooking apparatus 100.

Referring to FIGS. 12A and 12B, according to an example, the mounting part 310 may be inserted into and supported by the first through-hole 352-1, which extends in the first direction. Here, a certain gap may be formed between the mounting part 310 and the second support part 3511. According to an example, when the sensor device 30 is supported on the accommodation part 110 of the cooking apparatus 100, the side surface 112 of the accommodation part 110 may be located in a region between the mounting part 310 and the second support part 3511. In this case, because the region between the mounting part 310 and the second support part 3511 may be relatively narrow, the sensor unit 320 may be placed to be fixed at a position that is not excessively spaced apart from the bottom surface 111 of the accommodation part 110.

Referring to FIGS. 13A and 13B, according to an example, the mounting part 310 may be inserted into and supported by the second through-hole 352-2, which extends in the second direction. Here, a certain gap may be formed between the mounting part 310 and the second support part 3511. According to an example, when the sensor device 30 is supported on the accommodation part 110 of the cooking apparatus 100, the side surface 112 of the accommodation part 110 and the handle 113 having a certain width may be located in a region between the mounting part 310 and the second support part 3511. In this case, because the region between the mounting part 310 and the second support part 3511 may be relatively wide, the sensor unit 320 may be placed to be fixed at a position that is not excessively spaced apart from the bottom surface 111 of the accommodation part 110.

According to an example, the certain gap between the mounting part 310 and the second support part 3511 may be adjusted based on the angle at which the second through-hole 352-2 is inclined with respect to the first direction. Thus, depending on the shape of the side surface 112 of the accommodation part 110 on which the sensor device 30 is supported, the shape of the second through-hole 352-2 may be adjusted, or two or more through-holes may be arranged. Accordingly, the sensor device 30 may be mounted on cooking apparatuses 100 having various shapes.

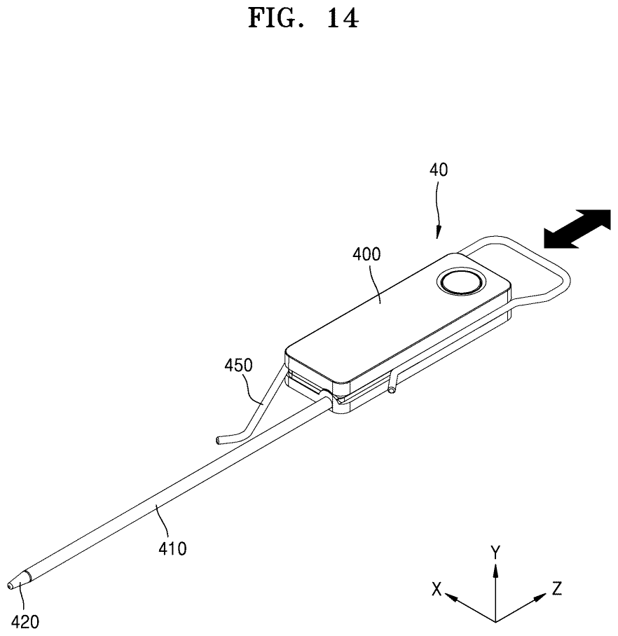

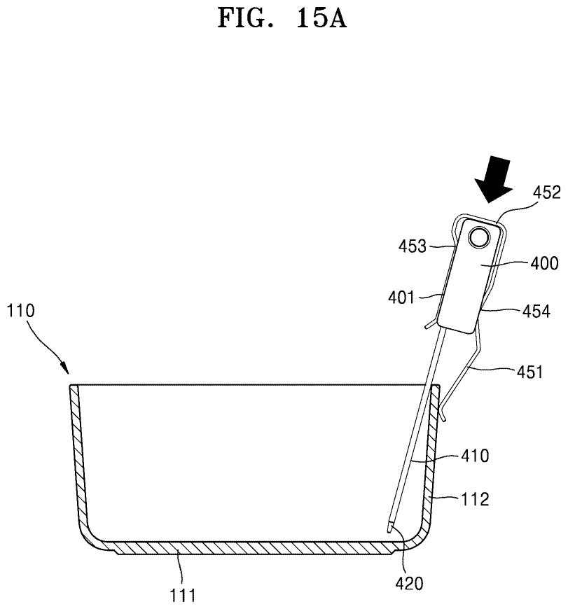

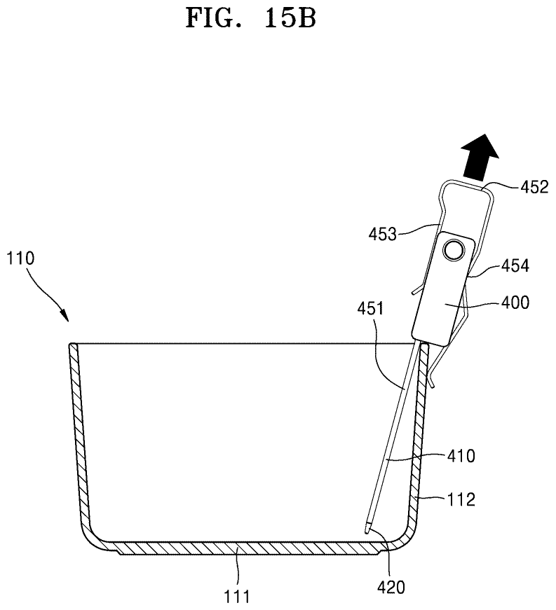

FIG. 14 is a perspective view of a sensor device according to an example. FIG. 15A is a cross-sectional view of a cooking apparatus equipped with a sensor device, according to an example. FIG. 15B is a cross-sectional view of a cooking apparatus equipped with a sensor device, according to an example.

Referring to FIGS. 14 to 15B, a sensor device 40 according to an example may include a main body part 400, a mounting part 410 arranged to be fixed to one end of the main body part 400, a sensor unit 420 arranged to be fixed to one end of the mounting part 410, and a position fixing part 450. Except that the mounting part 410 according to an example is not bendable clockwise or counterclockwise, the configurations associated with the main body part 400, the mounting part 410, and the sensor unit 420 are substantially the same as those of the main body part 200, the mounting part 210, and the sensor unit 220 described with above reference to FIGS. 2 and 3, and thus, detailed descriptions thereof will be omitted.

The position fixing part 450 may be arranged spaced apart from the mounting part 410 with a certain gap therebetween in one direction (X direction), which is perpendicular to another direction (Z direction). For example, the accommodation part 110 of the cooking apparatus 100 may be supported between the mounting part 410 and the position fixing part 450. Accordingly, the sensor device 40 may be supported on the accommodation part 110 of the cooking apparatus 100. For example, the position fixing part 450 may be arranged to move up or down in the other direction (Z direction) with respect to the main body part 400. As the position fixing part 450 is arranged to move up or down in the other direction (Z direction) with respect to the main body part 400, the sensor device 40 may be mounted to correspond to cooking apparatuses 100 having various shapes.

According to an example, the position fixing part 450 may include a fixing part 451, a pressing part 452, a slide part 453, and a position support part 454. The fixing part 451 may extend in the other direction (Z direction) to be arranged spaced apart from the mounting part 410 with a certain gap therebetween. According to an example, the fixing part 451 may include a shape of a wire or a plate extending along one plane. According to an example, the fixing part 451 may also include a material having an elastic force such that it is deformable in the one direction (X direction), which is perpendicular to the other direction (Z direction). However, the present disclosure is not limited thereto, and the fixing part 451 may include a material that is not deformable in the one direction (X direction), which is perpendicular to the other direction (Z direction).

The pressing part 452 may apply pressure such that the fixing part 451 moves in the other direction (Z direction) with respect to the main body part 400. For example, the pressing part 452 may be connected to one end of the fixing part 451 and arranged on an upper portion of the main body part 400. Accordingly, when a user applies pressure to the pressing part 452 in the other direction (Z direction), the fixing part 451 may move in the other direction (Z direction). For example, when the user applies downward pressure to the pressing part 452 in the other direction (Z direction), the fixing part 451 may move downward in the other direction (Z direction) with respect to the main body part 400. In addition, when the user applies upward pressure to the pressing part 452 in the other direction (Z direction), the fixing part 451 may move upward in the other direction (Z direction) with respect to the main body part 400.

The slide part 453 may guide a movement path along which the fixing part 451 moves in the other direction (Z direction). According to an example, a slide guide 401 extending in the other direction (Z direction) may be arranged on one side surface of the main body part 400. The slide part 453 may move in the other direction (Z direction) along the slide guide 401. Here, the fixing part 451 supported by the slide part 453 may move in the other direction (Z direction) together with the slide part 453.

The position support part 454 may fix the position of the fixing part 451 with respect to the main body part 400. For example, the position support part 454 may have the shape of a protrusion. In this case, a plurality of groove shapes may be arranged on another side surface of the main body part 400, spaced apart from each other with certain gaps in the other direction (Z direction). The position support part 454 may be inserted into any one of the plurality of groove shapes and be supported by the main body part 400. Here, the fixing part 451 supported by the position support part 454 may be supported to be fixed at a certain position that is spaced apart from the main body part 400, together with the position support part 454.

Referring to FIGS. 15A and 15B, the mounting part 410 according to an example may extend in the other direction (Z direction) and be supported by the main body part 400. Here, a certain gap may be formed between the mounting part 410 and the fixing part 451 that is included in the position fixing part 450, in the one direction (X direction) that is perpendicular to the other direction (Z direction). According to an example, when the sensor device 40 is supported on the accommodation part 110 of the cooking apparatus 100, the side surface 112 of the accommodation part 110 may be located between the mounting part 410 and the fixing part 451. In this case, because the height of the side surface 112 of the accommodation part 110 may differ between cooking apparatuses, the sensor unit 420 may be arranged to be fixed at a position that is excessively spaced apart from the bottom surface 111 of the accommodation part 110.

According to an example, the fixing part 451 may be moved up or down in the other direction (Z direction) with respect to the main body part 400. For example, as illustrated in FIG. 15A, in a case in which the height of the side surface 112 of the accommodation part 110 is relatively low, the user may apply downward pressure to the pressing part 452. Accordingly, the pressing part 452 may move downward in the other direction (Z direction). As the pressing part 452 moves downward, the fixing part 451 may also move downward in the other direction (Z direction) with respect to the main body part 400. Here, the movement path of the fixing part 451 may be determined by the slide part 453. In addition, the position of the fixing part 451 with respect to the main body part 400 may be supported by the position support part 454. As the fixing part 451 moves downward in the other direction (Z direction) with respect to the main body part 400, the sensor unit 420 may be placed to be fixed at a position that is not excessively spaced apart from the bottom surface 111 of the accommodation part 110, even in a case in which the side surface 112 of the accommodation part 110 is relatively low or thick.

In addition, as illustrated in FIG. 15B, in a case in which the height of the side surface 112 of the accommodation part 110 is relatively high, the user may apply upward pressure to the pressing part 452. Accordingly, the pressing part 452 may move upward in the other direction (Z direction). As the pressing part 452 moves upward, the fixing part 451 may also move upward in the other direction (Z direction) with respect to the main body part 400. Here, the movement path of the fixing part 451 may be determined by the slide part 453. In addition, the position of the fixing part 451 with respect to the main body part 400 may be supported by the position support part 454. As the fixing part 451 moves upward in the other direction (Z direction) with respect to the main body part 400, the sensor unit 420 may be placed to be fixed at a position that is not excessively spaced apart from the bottom surface 111 of the accommodation part 110, even in a case in which the side surface 112 of the accommodation part 110 is relatively high or thin. As described above, because the fixing part 451 is arranged to move up or down in the other direction (Z direction) with respect to the main body part 400, the sensor device 40 may be mounted on cooking apparatuses 100 having various shapes.

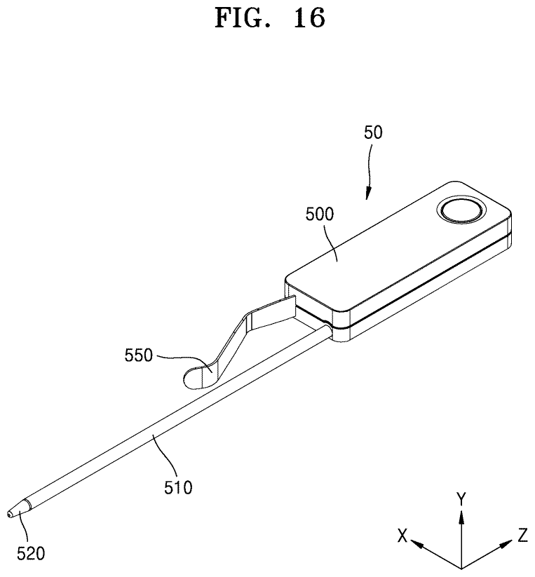

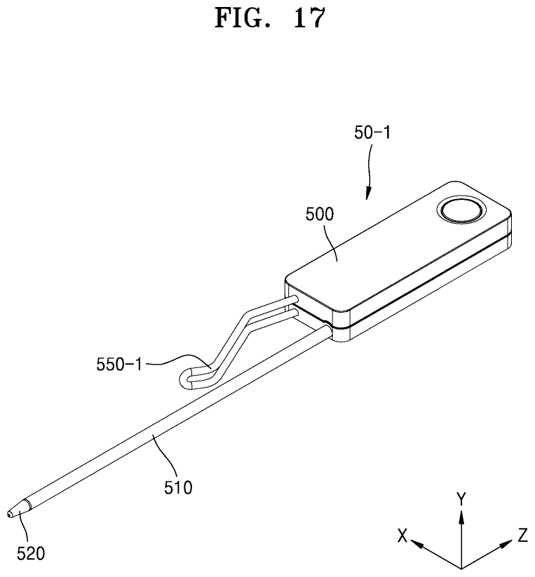

FIG. 16 is a perspective view of a sensor device according to an example. FIG. 17 is a perspective view of a sensor device according to an example.

Referring to FIGS. 16 and 17, a sensor device 50 or 50-1 according to an example may include a main body part 500, a mounting part 510 arranged to be fixed to one end of the main body part 500, a sensor unit 520 arranged to be fixed to one end of the mounting part 510, and a position fixing part 550 or 550-1. Except that the mounting part 510 according to an example is not bendable clockwise or counterclockwise, the configurations associated with the main body part 500, the mounting part 510, and the sensor unit 520 are substantially the same as those of the main body part 200, the mounting part 210, and the sensor unit 220 described with above reference to FIGS. 2 and 3, and thus, detailed descriptions thereof will be omitted.

Referring to FIG. 16, the position fixing part 550 according to an example may be arranged spaced apart from the mounting part 510 with a certain gap therebetween in the one direction (X direction), which is perpendicular to the other direction (Z direction). For example, the accommodation part 110 of the cooking apparatus 100 may be supported between the mounting part 510 and the position fixing part 550. Accordingly, the sensor device 50 may be supported on the cooking apparatus 100.

For example, the position fixing part 550 may be an elastic member extending in the other direction (Z direction). For example, the position fixing part 550 may be a wire-shaped elastic member extending in the other direction (Z direction). According to an example, one end of the position fixing part 550 may be an end fixed to the main body part 500. In addition, another end of the position fixing part 550 may be a free end deformable in the other direction (Z direction), which is perpendicular to the other direction (Z direction). Accordingly, even in a case in which the thickness of the accommodation part 110 of the cooking apparatus 100 to be placed between the mounting part 510 and the position fixing part 550 varies, the gap between the mounting part 510 and the position fixing part 550 may be adjusted. Thus, the sensor device 50 may be mounted on cooking apparatuses 100 having various shapes.

Referring to FIG. 17, the position fixing part 550-1 according to an example may be arranged spaced apart from the mounting part 510 with a certain gap therebetween in the one direction (X direction), which is perpendicular to the other direction (Z direction). For example, the accommodation part 110 of the cooking apparatus 100 may be supported between the mounting part 510 and the position fixing part 550-1. Accordingly, the sensor device 50-1 may be supported on the accommodation part 110 of the cooking apparatus 100.

For example, the position fixing part 550-1 may be an elastic member extending in the other direction (Z direction). For example, the position fixing part 550-1 may be a plate-shaped elastic member extending in the other direction (Z direction). According to an example, one end of the position fixing part 550-1 may be an end fixed to the main body part 500. In addition, another end of the position fixing part 550-1 may be a free end deformable in the other direction (Z direction), which is perpendicular to the other direction (Z direction). Accordingly, even in a case in which the thickness of the accommodation part 110 of the cooking apparatus 100 to be placed between the mounting part 510 and the position fixing part 550-1 varies, the gap between the mounting part 510 and the position fixing part 550-1 may be adjusted. Thus, the sensor device 50-1 may be mounted on cooking apparatuses 100 having various shapes.

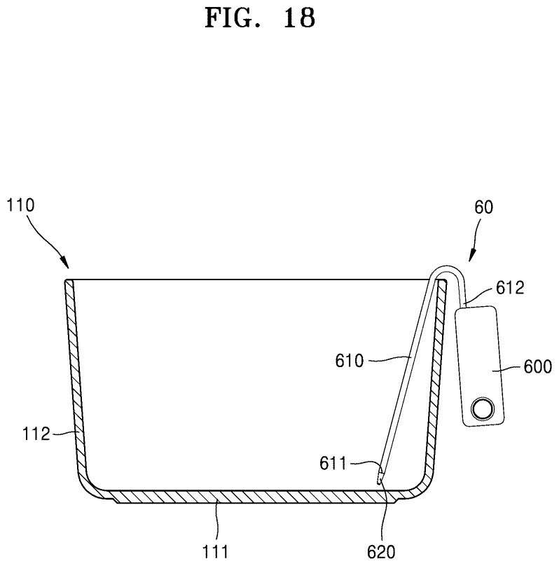

FIG. 18 is a cross-sectional view of a cooking apparatus equipped with a sensor device, according to an example.

Referring to FIG. 18, a sensor device 60 according to an example may include a main body part 600, a mounting part 610 arranged to be fixed to one end of the main body part 600, and a sensor unit 620 arranged to be fixed to one end of the mounting part 610. Except for the mounting part 610 according to an example, the configurations associated with the main body part 600 and the sensor unit 620 are substantially the same as those of the main body part 200 and the sensor unit 220 described above with reference to FIGS. 2 and 3, and thus, detailed descriptions thereof will be omitted.

The mounting part 610 may be arranged between the main body part 600 and the sensor unit 620 to connect the main body part 600 and the sensor unit 620 to each other. The mounting part 610 according to an example may extend in one direction. Here, one end 611 of the mounting part 610 may be arranged to be fixed to the sensor unit 620. In addition, another end 612 of the mounting part 610 may be arranged to be fixed to the main body part 600.

The mounting part 610 according to an example may be bent one or more times in a certain direction. For example, the mounting part 610 may include a tube shape that may be bent clockwise or counterclockwise in a longitudinal direction in which the mounting part 610 extends. For example, the mounting part 610 may be bent clockwise or counterclockwise by an angle greater than 0 degrees and less than 150 degrees in the longitudinal direction in which the mounting part 610 extends.

The sensor device 60 according to an example may be arranged to be mounted on the cooking apparatus 100. According to an example, the shape of the mounting part 610 may be deformed to correspond to the shape of the side surface 112 of the cooking apparatus 100 in which the sensor device 60 is accommodated. For example, in a case in which the side surface 112 of the cooking apparatus 100 has a certain height, the mounting part 610 may be bent such that the sensor unit 620 is fixed at a position that is not excessively spaced apart from the bottom surface 111 of the cooking apparatus 100. As described above, because the mounting part 610 is bendable to correspond to the shape of the cooking apparatus 100, the sensor device 60 may be mounted on cooking apparatuses 100 having various shapes.

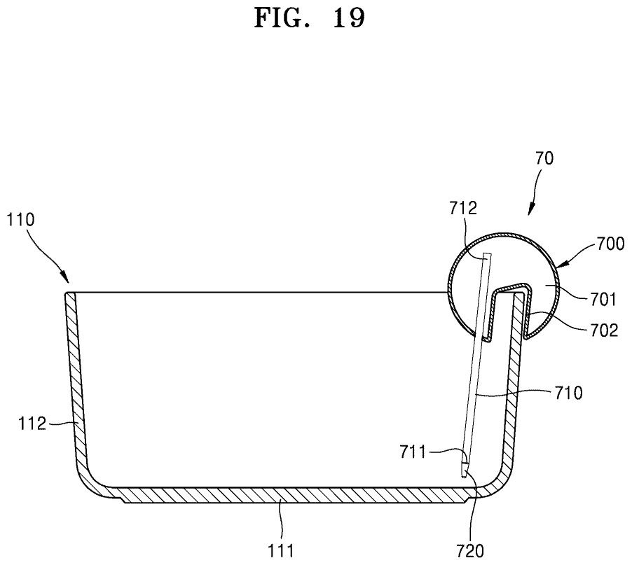

FIG. 19 is a cross-sectional view of a cooking apparatus equipped with a sensor device, according to an example.

Referring to FIG. 19, a sensor device 70 according to an example may include a main body part 700, a mounting part 710 arranged to be fixed to one end of the main body part 700, and a sensor unit 720 arranged to be fixed to one end of the mounting part 710. Except for the main body part 700 according to an example and except that the mounting part 710 according to an example is not bendable clockwise or counterclockwise, the configurations associated with the mounting part 710 and the sensor unit 720 are substantially the same as those of the mounting part 210 and the sensor unit 220 described above with reference to FIGS. 2 and 3, and thus, detailed descriptions thereof will be omitted.

According to an example, the main body part 700 may include, a gripping part 701 having an external appearance configured to be gripped by a user, and a support groove 702 for supporting the sensor device 70 on the cooking apparatus 100. Another end 712 of the mounting part 710 may be supported by the main body part 700, for example, by the gripping part 701, and the sensor unit 720 may be supported by one end 711 of the mounting part 710. For example, the gripping part 701 may have a shape that allows a user to grip the sensor device 70. Although FIG. 19 illustrates a circular plate as the gripping part 701, the present disclosure is not limited thereto.

The support groove 702 may have a groove shape with a certain depth. According to an example, when the sensor device 70 is placed to be mounted on the cooking apparatus 100, it may be placed such that the side surface 112 of the cooking apparatus 100 is inserted into the support groove 702. For example, the width of the support groove 702 may be adjusted to increase or decrease. Thus, when the side surface 112 of the cooking apparatus 100 is supported in the support groove 702, the width of the support groove 702 may be adjusted to correspond to the thickness of the side surface 112 of any one of various cooking apparatuses 100. As the width of the support groove 702 is adjusted according to the shape of the cooking apparatus 100, the sensor device 70 may be mounted on cooking apparatuses 100 having various shapes.

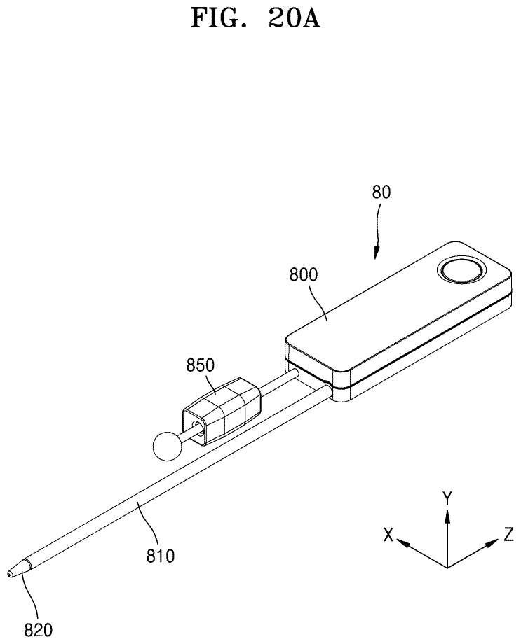

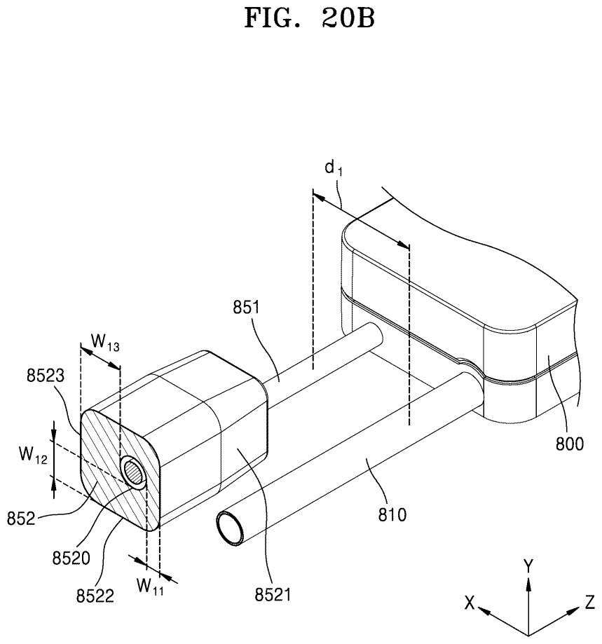

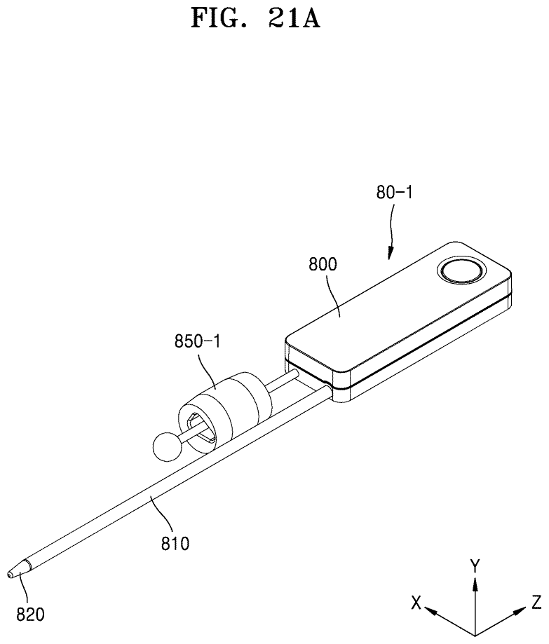

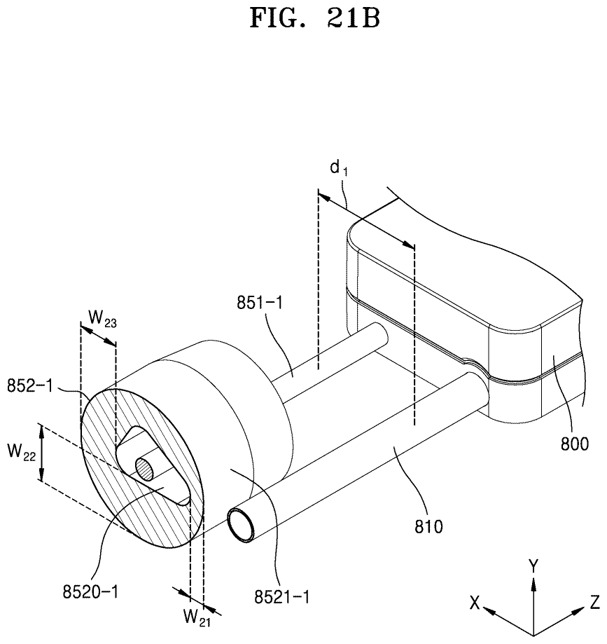

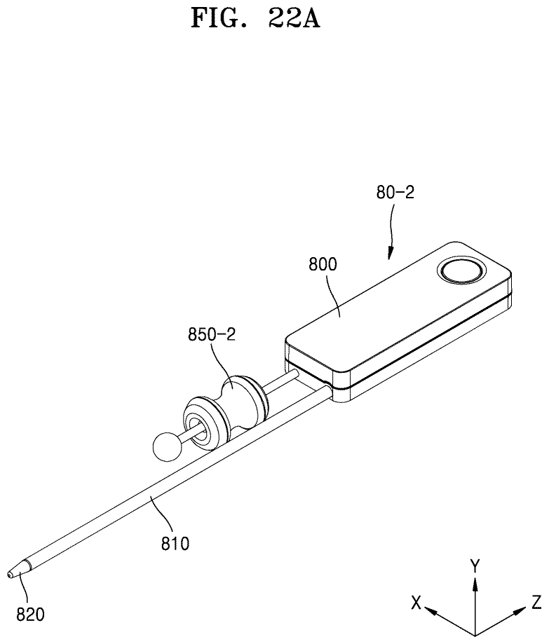

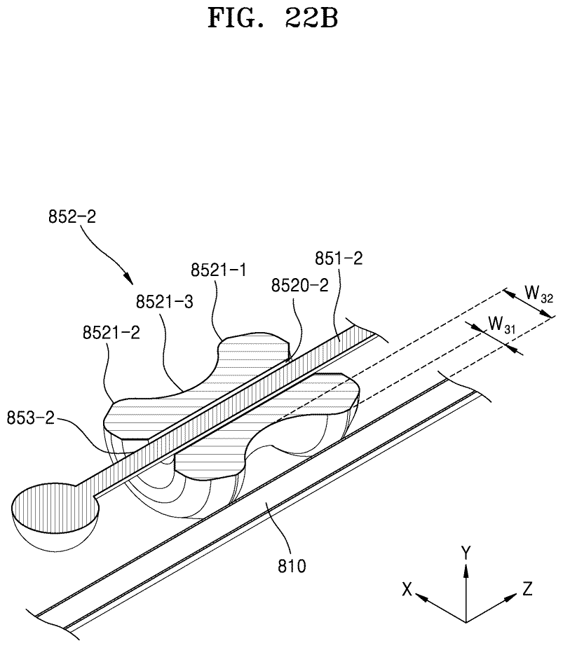

FIG. 20A is a perspective view of a sensor device according to an example. FIG. 20B is a partial enlarged view of a sensor device according to an example. FIG. 21A is a perspective view of a sensor device according to an example. FIG. 21B is a partial enlarged view of a sensor device according to an example. FIG. 22A is a perspective view of a sensor device according to an example. FIG. 22B is a partial cross-sectional view of a sensor device according to an example.

Referring to FIGS. 20A and 20B, a sensor device 80 according to an example may include a main body part 800, a mounting part 810 arranged to be fixed to one end of the main body part 800, a sensor unit 820 arranged to be fixed to one end of the mounting part 810, and a position fixing part 850. Except that the mounting part 810 according to an example is not bendable clockwise or counterclockwise, the configurations associated with the main body part 800, the mounting part 810, and the sensor unit 820 are substantially the same as those of the main body part 200, the mounting part 210, and the sensor unit 220 described above with reference to FIGS. 2 and 3, and thus, detailed descriptions thereof will be omitted.

The position fixing part 850 may be arranged spaced apart from the mounting part 810 with a certain gap therebetween in the one direction (X direction), which is perpendicular to the other direction (Z direction). For example, the accommodation part 110 of the cooking apparatus 100 may be supported between the mounting part 810 and the position fixing part 850. Accordingly, the sensor device 80 may be supported on the accommodation part 110 of the cooking apparatus 100. For example, the separation gap between the position fixing part 850 and the mounting part 810 may increase or decrease. As the separation gap between the position fixing part 850 and the mounting part 810 is adjusted, the sensor device 80 may be mounted on cooking apparatuses 100 having various shapes.

The position fixing part 850 may include a support rod 851 extending in the other direction (Z direction), and an eccentric support body 852 having a through-hole 8520 into which the support rod is inserted. According to an example, the support rod 851 may be arranged spaced apart from the mounting part 810 with a certain first gap d₁ therebetween in the one direction (X direction), which is perpendicular to the other direction (Z direction). One end of the support rod 851 may be arranged to be fixed to the main body part 800, and another end of the support rod 851 may pass through the through-hole 8520 provided in the eccentric support body 852, and be supported by the eccentric support body 852. Here, the support rod 851 may be arranged to be eccentric with respect to the center of the eccentric support body 852.

According to an example, the eccentric support body 852 may be arranged spaced apart from the mounting part 810 with a certain gap therebetween in the one direction (X direction), which is perpendicular to the other direction (Z direction). For example, the through-hole 8520 arranged in the eccentric support body 852 may be arranged at an eccentric position that is offset from the center of the eccentric support body 852. Accordingly, when the eccentric support body 852 rotates about the support rod 851, the separation gap between the eccentric support body 852 and the mounting part 810 may change.

For example, a first width W₁₁ may be defined between a first side surface 8521 of the eccentric support body 852 and the through-hole 8520. When the eccentric support body 852 is arranged such that the first side surface 8521 faces the mounting part 810, the gap between the eccentric support body 852 and the mounting part 810 may be determined as the difference between the first gap d₁ and the first width W₁₁ (d₁−W₁₁).

In addition, for example, a second width W₁₂ may be defined between a second side surface 8522 of the eccentric support body 852 and the through-hole 8520. For example, when the eccentric support body 852 rotates about the support rod 851 to be arranged such that the second side surface 8522 faces the mounting part 810, the gap between the eccentric support body 852 and the mounting part 810 may change to the difference between the first gap d₁ and the second width W₁₂ (d₁−W₁₂).

In addition, for example, a third width W₁₃ may be defined between a third side surface 8523 of the eccentric support body 852 and the through-hole 8520. For example, when the eccentric support body 852 rotates about the support rod 851 to be arranged such that the third side surface 8523 faces the mounting part 810, the gap between the eccentric support body 852 and the mounting part 810 may change to the difference between the first gap d₁ and the third width W₁₃ (d₁−W₁₃).

As described above, because the separation gap between the eccentric support body 852 and the mounting part 810 changes, the side surface 112 of any one of cooking apparatuses 100 having various thicknesses may be arranged between the eccentric support body 852 and the mounting part 810. Thus, the sensor device 80 may be mounted on cooking apparatuses 100 having various shapes.

Referring to FIGS. 21A and 21B, a sensor device 80-1 according to an example may include the main body part 800, the mounting part 810 arranged to be fixed to one end of the main body part 800, the sensor unit 820 arranged to be fixed to one end of the mounting part 810, and a position fixing part 850-1. Except that the mounting part 810 according to an example is not bendable clockwise or counterclockwise, the configurations associated with the main body part 800, the mounting part 810, and the sensor unit 820 are substantially the same as those of the main body part 200, the mounting part 210, and the sensor unit 220 described above with reference to FIGS. 2 and 3, and thus, detailed descriptions thereof will be omitted.

The position fixing part 850-1 may be arranged spaced apart from the mounting part 810 with a certain gap therebetween in the one direction (X direction), which is perpendicular to the other direction (Z direction). In addition, according to an example, the position fixing part 850-1 may include a support rod 851-1 extending in the other direction (Z direction), and an eccentric support body 852-1 having a through-hole 8520-1 into which the support rod is inserted. Except for the eccentric support body 852-1, the configuration is substantially the same as that of the position fixing part 850 illustrated in FIGS. 20A and 20B, and thus, detailed descriptions thereof will be omitted.

According to an example, the eccentric support body 852-1 may be arranged spaced apart from the mounting part 810 with a certain gap therebetween in the one direction (X direction), which is perpendicular to the other direction (Z direction). For example, the through-hole 8520-1 arranged in the eccentric support body 852-1 may be arranged at an eccentric position that is offset from the center of the eccentric support body 852-1. Accordingly, when the eccentric support body 852-1 rotates about the support rod 851-1, the separation gap between the eccentric support body 852-1 and the mounting part 810 may change.

For example, a first width W₂₁ may be defined between a side surface 8521-1 of the eccentric support body 852-1 and the through-hole 8520-1. When the eccentric support body 852-1 is arranged such that the side surface 8521-1 faces the mounting part 810, the gap between the eccentric support body 852-1 and the mounting part 810 may be determined as the difference between the first gap d₁ and the first width W₂₁ (d₁−W₂₁).

In addition, for example, a second width W₂₂ may be defined between the side surface 8521-1 of the eccentric support body 852-1 and the through-hole 8520-1. For example, when the eccentric support body 852-1 rotates about the support rod 851-1 to be arranged such that the side surface 8521-1 of the eccentric support body 852-1 faces the mounting part 810, the gap between the eccentric support body 852-1 and the mounting part 810 may be determined as the difference between the first gap d₁ and the second width W₂₂ (d₁−W₂₂).

In addition, for example, a third width W₂₃ may be defined between the side surface 8521-1 of the eccentric support body 852-1 and the through-hole 8520-1. For example, when the eccentric support body 852-1 rotates about the support rod 851-1 to be arranged such that the side surface 8521-1 of the eccentric support body 852-1 faces the mounting part 810, the gap between the eccentric support body 852-1 and the mounting part 810 may change to the difference between the first gap d₁ and the third width W₂₃ (d₁−W₂₃).

Referring to FIGS. 22A and 22B, a sensor device 80-2 according to an example may include the main body part 800, the mounting part 810 arranged to be fixed to one end of the main body part 800, the sensor unit 820 arranged to be fixed to one end of the mounting part 810, and a position fixing part 850-2. Except that the mounting part 810 according to an example is not bendable clockwise or counterclockwise, the configurations associated with the main body part 800, the mounting part 810, and the sensor unit 820 are substantially the same as those of the main body part 200, the mounting part 210, and the sensor unit 220 described above with reference to FIGS. 2 and 3, and thus, detailed descriptions thereof will be omitted.

The position fixing part 850-2 may be arranged spaced apart from the mounting part 810 with a certain gap therebetween in the one direction (X direction), which is perpendicular to the other direction (Z direction). For example, the accommodation part 110 of the cooking apparatus 100 may be supported between the mounting part 810 and the position fixing part 850-2. Accordingly, the sensor device 80-2 may be supported on the accommodation part 110 of the cooking apparatus 100. For example, a plurality of separation gaps between the position fixing part 850-2 and the mounting part 810 may be set. As a plurality of separation gaps between the position fixing part 850-2 and the mounting part 810 are set, the sensor device 80-2 may be mounted on cooking apparatuses 100 having various shapes.

The position fixing part 850-2 may include a support rod 851-2 extending in the other direction (Z direction), and a concentric support body 852-2 having a through-hole 8520-2 into which the support rod is inserted. According to an example, the support rod 851-2 may be arranged spaced apart from the mounting part 810 with a certain gap therebetween in the one direction (X direction), which is perpendicular to the other direction (Z direction). One end of the support rod 851-2 may be arranged to be fixed to the main body part 800, and another end of the support rod 851-2 may pass through the through-hole 8520-2 provided in the concentric support body 852-2, and be supported by the concentric support body 852-2. Here, the support rod 851-2 may be arranged at the center of the concentric support body 852-2.

According to an example, the concentric support body 852-2 may be arranged spaced apart from the mounting part 810 with a plurality of gaps therebetween in the one direction (X direction), which is perpendicular to the other direction (Z direction). For example, the concentric support body 852-2 may have a shape whose width in the one direction (X direction) varies in the other direction (Z direction). Accordingly, the separation gap between the concentric support body 852-2 and the mounting part 810 may vary in the other direction (Z direction).

For example, an upper region 8521-1 and a lower region 8521-2 of the concentric support body 852-2 may define a first width W₃₁ with respect to the mounting part 810 in the one direction (X direction). In addition, a central region 8521-3 between the upper region 8521-1 and the lower region 8521-2 of the concentric support body 852-2 may define a second width W₃₂ with respect to the mounting part 810 in the one direction (X direction). For example, in a case in which the second width W₃₂ is greater than the first width W₃₁, the concentric support body 852-2 may have a shape with a concave central portion.

According to an example, when the concentric support body 852-2 is arranged to face the mounting part 810, the gap between the concentric support body 852-2 and the mounting part 810 may be determined differently along a first direction (Z direction), as the first width W₃₁ or the second width W₃₂.

As described above, because the separation gap between the concentric support body 852-2 and the mounting part 810 varies, cooking apparatuses 100 having various shapes, for example, a cooking apparatus 100 having both the side surface 112 and the handle 113 as illustrated in FIG. 5, may be placed between the concentric support body 852-2 and the mounting part 810. For example, the side surface 112 of a cooking apparatus, which is relatively narrow, may be placed between the upper region 8521-1 or the lower region 8521-2 of the concentric support body 852-2 and the mounting part 810. In addition, the handle 113 of a cooking apparatus, which is relatively wide, may be arranged between the central region 8521-3 of the concentric support body 852-2 and the mounting part 810. Thus, the sensor device 80-2 may be mounted on cooking apparatuses 100 having various shapes.

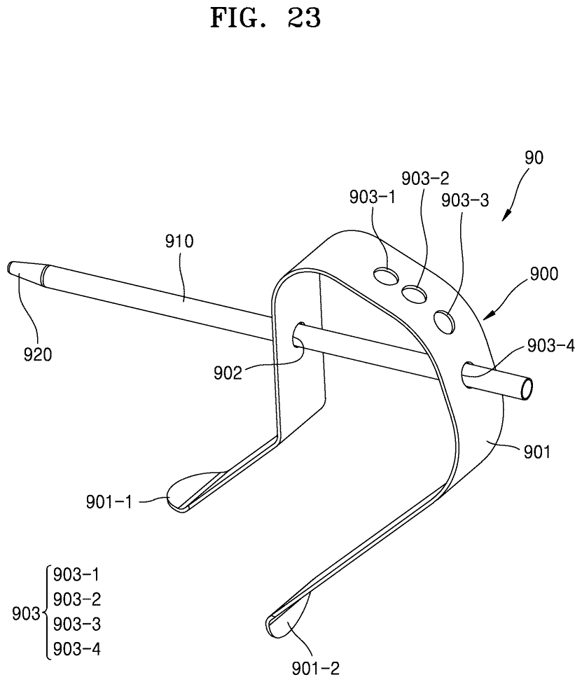

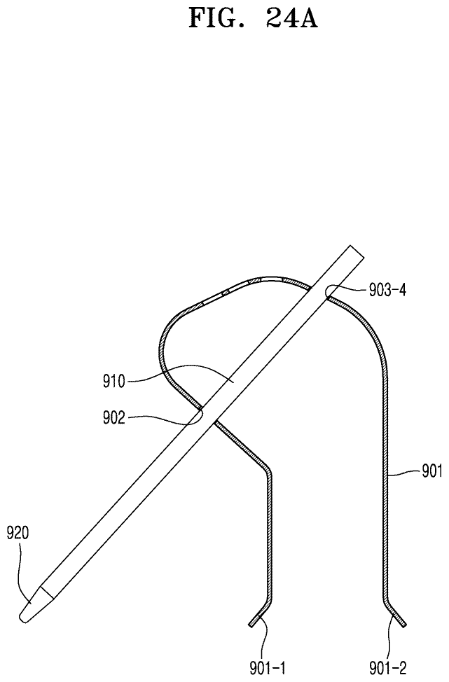

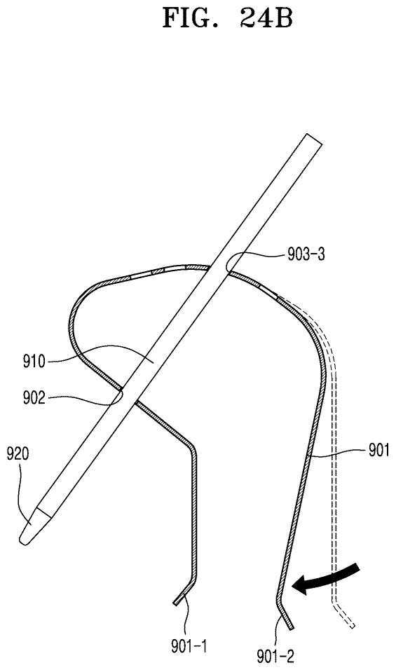

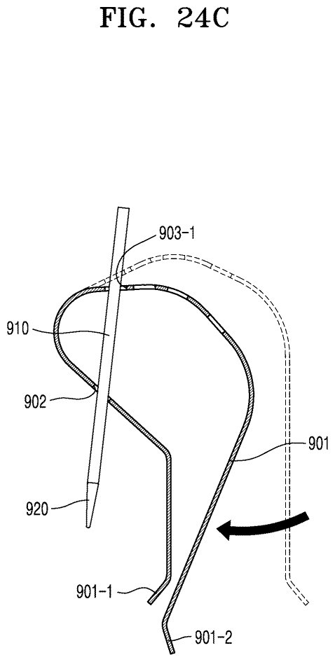

FIG. 23 is a perspective view of a sensor device according to an example. FIG. 24A is a side view of a sensor device according to an example. FIG. 24B is a side view of a sensor device according to an example. FIG. 24C is a side view of a sensor device according to an example.

Referring to FIG. 23, a sensor device 90 according to an example may include a main body part 900, a mounting part 910 supported so as to be fixed to the main body part 900, and a sensor unit 920 arranged to be fixed to one end of the mounting part 910. Except for the main body part 900 according to an example and except that the mounting part 910 according to an example is not bendable clockwise or counterclockwise, the configurations associated with the mounting part 910 and the sensor unit 920 are substantially the same as those of the mounting part 210 and the sensor unit 220 described above with reference to FIGS. 2 and 3, and thus, detailed descriptions thereof will be omitted.

According to an example, the main body part 900 may include a support plate 901 extending in one direction, a first insertion hole 902 arranged in the support plate 901, and a plurality of second insertion holes 903 arranged spaced apart from the first insertion hole 902 with certain gaps therebetween. For example, the support plate 901 may extend in one direction and may be provided in a plate shape with elastic force. For example, the support plate 901 may be implemented as a plate spring, but the present disclosure is not limited thereto. According to an example, the support plate 901 may be bent such that one end 901-1 and another end 901-2 thereof face each other. For example, the side surface 112 of a cooking apparatus may be placed and supported between the end 901-1 and the end 901-2 of the support plate 901. Here, the separation gap between the end 901-1 and the end 901-2 of the support plate 901 may be adjusted to increase or decrease. Thus, the side surface 112 of cooking apparatuses having various thicknesses may be supported between the end 901-1 and the end 901-2 of the support plate 901.

The first insertion hole 902 may be arranged in the support plate 901. For example, the first insertion hole 902 may be arranged at a position closer to the end 901-1 of the support plate 901 than the plurality of second insertion holes 903 are. The diameter of the first insertion hole 902 may be less than the diameter of the mounting part 910. Accordingly, when the mounting part 910 is inserted into the first insertion hole 902, the mounting part 910 may be supported by the support plate 901 via an interference fit.

The plurality of second insertion holes 903 may be arranged in the support plate 901. For example, the plurality of second insertion holes 903 may be arranged at positions closer to the end 901-2 of the support plate 901 than the plurality of first insertion holes 902 are. The diameters of the plurality of second insertion holes 903 may be less than the diameter of the mounting part 910. Accordingly, when the mounting part 910 is inserted into any one of the plurality of second insertion holes 903, the mounting part 910 may be supported by the support plate 901 via an interference fit.

According to an example, the mounting part 910 may be inserted into the first insertion hole 902 and any one of the plurality of second insertion holes 903 so as to be supported by the support plate 901. For example, the plurality of second insertion holes 903 may include a second-1 insertion hole 903-1 to a second-4 insertion hole 903-4, which are arranged spaced apart from each other with certain gaps therebetween.

As illustrated in FIG. 24A, when the separation gap between the end 901-1 and the end 901-2 of the support plate 901 is relatively wide, the mounting part 910 may be inserted into the first insertion hole 902 and the second-4 insertion hole 903-4 so as to be supported by the support plate 901.

In addition, as illustrated in FIG. 24B, when the separation gap between the end 901-1 and the end 901-2 of the support plate 901 is narrower than the separation gap illustrated in FIG. 24A, the mounting part 910 may be inserted into the first insertion hole 902 and the second-3 insertion hole 903-3 so as to be supported by the support plate 901.

In addition, as illustrated in FIG. 24C, when the separation gap between the end 901-1 and the end 901-2 of the support plate 901 is narrower than the separation gap illustrated in FIG. 24B, the mounting part 910 may be inserted into the first insertion hole 902 and the second-1 insertion hole 903-1 so as to be supported by the support plate 901.

As described above, as the separation gap between the end 901-1 and the end 901-2 of the support plate 901 increases or decreases, the side surface 112 of cooking apparatuses having various thicknesses may be supported between the end 901-1 and the end 901-2 of the support plate 901. Here, in all cases, the mounting part 910, which extends in one direction, may be inserted into the first insertion hole 902 and supported. In addition, the mounting part 910 may be inserted into any one of the plurality of second insertion holes 903 and supported. Accordingly, the mounting part 910 may be supported by the support plate 901 while maintaining a certain insertion angle, regardless of an increase or decrease in the separation gap between the end 901-1 and the end 901-2 of the support plate 901.

For the purposes of promoting understanding of the disclosure, reference numerals are used in the preferred embodiments illustrated in the drawings, and particular terms are used to describe the embodiments, however, the disclosure is not limited by the terms and should be construed to encompass all components that would normally occur to those skilled in the art.

Particular executions described herein are merely examples and do not limit the scope of the disclosure in any way. For the sake of brevity, related-art electronics, control systems, software and other functional aspects of the systems may not be described in detail. Furthermore, line connections or connection members between elements depicted in the drawings represent functional connections and/or physical or circuit connections by way of example, and in actual applications, they may be replaced or embodied with various suitable additional functional connections, physical connections, or circuit connections. In addition, no item or component is essential to the practice of the disclosure unless the item or component is specifically described as being “essential” or “critical”. As used herein, terms such as “comprising” or “including” are used to be understood as being an open-ended term for description.

The term ‘the’ and other demonstratives similar thereto in the specification of the disclosure (especially in the following claims) should be understood to include a singular form and plural forms. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the operations of the methods described herein may be performed in any suitable order unless otherwise indicated herein or otherwise clearly contradicted by context. The present disclosure is not limited to the described order of the operations. The use of any and all examples, or exemplary language (e.g., ‘and the like’) provided herein, is intended merely to better illuminate the present disclosure and does not pose a limitation on the scope of the present disclosure unless otherwise claimed. Furthermore, various changes and modifications will be readily apparent to one of ordinary skill in the art without departing from the spirit and scope of the disclosure.

A sensor device according to an example may include a main body part, a mounting part arranged to be fixed to one end of the main body part, extending in one direction, and configured to be bent one or more times in a predetermined direction, and a sensor unit arranged to be fixed to one end of the mounting part.

The mounting part may include at least one of a stainless steel tube or a silicone tube.

The mounting part may include a material that is deformable in a thickness direction in response to external pressure being applied.

The sensor device may further include a position adjustment unit arranged to surround a portion of the sensor unit and having a predetermined weight.

One end of the sensor unit and one end of the position adjustment unit may be arranged spaced apart from each other with a predetermined gap therebetween.

The sensor device may further include a communication module configured to perform wired communication or wireless communication with an external electronic device.

The sensor device may further include a first holder including one or more through-holes into which the mounting part is inserted.

The first holder may include a first through-hole, a second through-hole, and a third through-hole, wherein the first through-hole may have a shape bent at a predetermined angle, the second through-hole may have a shape extending in a first direction, and the third through-hole may have a shape extending in a second direction that is inclined at a certain angle with respect to the first direction.

A sensor device according to an example may include a main body part, a mounting part arranged to be fixed to one end of the main body part and extending in one direction, a sensor unit arranged to be fixed to one end of the mounting part, and a second holder including a support part that is bent at a predetermined angle, and one or more through-holes arranged in the support part and into which the mounting part is inserted.

The second holder may include a first through-hole and a second through-hole, wherein the first through-hole may have a shape extending in a first direction, and the second through-hole may have a shape extending in a second direction that is inclined at a predetermined angle with respect to the first direction.

A sensor device according to an example may include a main body part, a mounting part arranged to be fixed to one end of the main body part and extending in one direction, a sensor unit arranged to be fixed to one end of the mounting part, and a position fixing part arranged spaced apart from the mounting part with a predetermined gap therebetween in another direction perpendicular to the one direction.

The position fixing part may be arranged to move up or down in the one direction with respect to the main body part.

The position fixing part may be an elastic member extending in the one direction, one end of the position fixing part may be fixed to the main body part, and another end of the position fixing part may be deformable in the other direction.

The position fixing part may include a support rod extending in the one direction and having one end fixed to the main body part, and an eccentric support body that includes a through-hole into which the support rod is inserted, and is arranged spaced apart from the mounting part in the other direction, and the support rod may be arranged to be eccentric with respect to a center of the eccentric support body.

The position fixing part may include a support rod extending in the one direction and having one end fixed to the main body part, and a concentric support body that extends to have different widths in the one direction, includes a through-hole into which the support rod is inserted, and is arranged spaced apart from the mounting part in the other direction, and the concentric support body and the support rod may be arranged to be spaced apart from each other with a plurality of gaps therebetween in the one direction.

1. A sensor device comprising:
a main body part;
a mounting part arranged to be fixed to one end of the main body part, the mounting part is configured to extend along one direction and be bent one or more times including being bent along the one direction subsequent to being bent along a predetermined direction different from the one direction; and
a sensor unit arrangeable to be fixed to one end of the mounting part.

2. The sensor device of claim 1, wherein the mounting part comprises at least one of a stainless steel tube or a silicone tube.

3. The sensor device of claim 1, wherein the mounting part comprises a material that is deformable along a thickness direction of the mounting part based on external pressure being applied.

4. The sensor device of claim 1, further comprising a position adjustment unit having a predetermined weight and arrangeable to surround a portion of the sensor unit and.

5. The sensor device of claim 4, wherein one end of the sensor unit and one end of the position adjustment unit are arranged spaced apart from each other with a predetermined gap therebetween.

6. The sensor device of claim 1, further comprising a communication module configured to perform wired communication or wireless communication with an external electronic device.

7. The sensor device of claim 1, further comprising a holder comprising one or more through-holes into which the mounting part is insertable.

8. The sensor device of claim 7, wherein the holder comprises a first through-hole, a second through-hole, and a third through-hole, the first through-hole has a shape that is bent at a predetermined angle,
the second through-hole has a shape that extends along a first direction, and
the third through-hole has a shape that extends along a second direction that is inclined at a predetermined angle with respect to the first direction.

9. A sensor device comprising:
a main body part;
a mounting part arranged to be fixed to one end of the main body part and extending along one direction;
a sensor unit arrangeable to be fixed to another end of the mounting part; and
a holder comprising a support part that is bendable at a predetermined angle, and one or more through-holes arranged in the support part and into which the mounting part is insertable.

10. The sensor device of claim 9, wherein the holder comprises a first through-hole and a second through-hole,
the first through-hole has a shape that extends along a first direction, and
the second through-hole has a shape that extends along a second direction that is inclined at a predetermined angle with respect to the first direction.

11. A sensor device comprising:
a main body part;
a mounting part arranged to be fixed to one end of the main body part and extending along one direction;
a sensor unit arrangeable to be fixed to one end of the mounting part; and
a position fixing part arrangeable spaced apart from the mounting part with a predetermined gap therebetween in another direction perpendicular to the one direction.

12. The sensor device of claim 11, wherein the position fixing part is arranged to move up or down along the one direction with respect to the main body part.

13. The sensor device of claim 11, wherein the position fixing part is an elastic member extending in the one direction,
one end of the position fixing part is fixed to the main body part, and another end of the position fixing part is deformable in another direction.

14. The sensor device of claim 11, wherein the position fixing part comprises:
a support rod extending along the one direction and having one end fixed to the main body part, and
an eccentric support body that comprises a through-hole into which the support rod is inserted, and is arranged spaced apart from the mounting part in another direction, and
wherein the support rod is arranged to be eccentric with respect to a center of the eccentric support body.

15. The sensor device of claim 11, wherein the position fixing part comprises:
a support rod extends along the one direction and has one end fixed to the main body part, and
a concentric support body that extends to have different widths along the one direction, comprises a through-hole into which the support rod is inserted, and is arranged spaced apart from the mounting part in another direction, and
the concentric support body and the support rod are arranged to be spaced apart from each other with a plurality of gaps therebetween in the one direction.
